(19) United States
(12) Patent Application Publication
(10) Pub. No.: US 2025/0201074 A1
(43) Pub. Date: Jun. 19, 2025

(54) TRACKING PROCESSED FUNDS IN ASSOCIATION WITH SERVICING A GAMING ESTABLISHMENT DEVICE

(71) Applicant: IGT, Las Vegas, NV (US)

(72) Inventors: Kevin Higgins, Reno, NV (US); Erik Petersen, Sparks, NV (US)

(21) Appl. No.: 18/543,270

(22) Filed: Dec. 18, 2023

(51) Int. Cl. G07F 17/32; G06Q 20/40

(52) U.S. Cl. CPC G07F 17/3248; G06Q 20/4016; G07F 17/3225

(57) ABSTRACT

Systems and methods that track funds processed at a gaming establishment device in association with a servicing of the gaming establishment device and employ such tracking to detect potential fraudulent behavior by gaming establishment personnel.

### BACKGROUND

In various embodiments, the systems and methods of the present disclosure track funds processed at a gaming establishment device in association with a servicing of the gaming establishment device and employ such tracking to detect potential fraudulent behavior by gaming establishment personnel.

Gaming machines may provide players awards in primary games. Gaming machines generally require the player to place a wager of credits to activate the primary game. The award of credits may be based on the player obtaining a winning symbol or symbol combination and on the amount of the wager.

### BRIEF SUMMARY

In certain embodiments, the present disclosure relates to a system including a processor, and a memory device that stores a plurality of instructions. When executed by the processor following a receipt of first data associated with a gaming establishment personnel identification device and an establishment, based at least in part on the first data, of a designated mode of a gaming establishment device, the instructions cause the processor to determine if any currency is received in association with the gaming establishment device. When executed by the processor responsive to an amount of currency being received in association with the gaming establishment device, the instructions cause the processor to determine any issuance of any ticket vouchers in association with the gaming establishment device. When executed by the processor responsive to an issuance of a ticket voucher in association with the gaming establishment device, the instructions cause the processor to communicate, to a component of a gaming establishment device management system, data associated with the receipt of the amount of currency, the occurrence of the issuance of the ticket voucher and second data associated with the gaming establishment personnel identification device.

In certain embodiments, the present disclosure relates to a system including a processor, and a memory device that stores a plurality of instructions. When executed by the processor following enabling an identified electronic gaming machine operator access to service an electronic gaming machine and in association with a determined clearing of a meter of the electronic gaming machine, the instructions cause the processor to determine any receipt of any currency by a payment acceptor of the electronic gaming machine. When executed by the processor responsive to an amount of currency being received by the payment acceptor of the electronic gaming machine, the instructions cause the processor to determine any printing of any ticket vouchers by a ticket printer of the electronic gaming machine. When executed by the processor responsive to a ticket voucher being printed, the instructions cause the processor to communicate, to a component of a gaming establishment device management system, data associated with each of the receipt of the amount of currency, the occurrence of the printing of the ticket voucher and the identified electronic gaming machine operator.

In certain embodiments, the present disclosure relates to a method of operating a system. Following a receipt of first data associated with a gaming establishment personnel identification device and an establishment, based at least in part on the first data, of a designated mode of a gaming establishment device, the method includes determining, by a processor, if any currency is received in association with the gaming establishment device. Responsive to an amount of currency being received in association with the gaming establishment device, the method includes determining, by the processor, any issuance of any ticket vouchers in association with the gaming establishment device, and, responsive to an issuance of a ticket voucher in association with the gaming establishment device, communicating, to a component of a gaming establishment device management system, data associated with the receipt of the amount of currency, the occurrence of the issuance of the ticket voucher and second data associated with the gaming establishment personnel identification device.

Additional features are described herein, and will be apparent from the following Detailed Description and the figures.

### BRIEF DESCRIPTION OF THE SEVERAL VIEWS OF THE DRAWINGS

FIG. 1 is an example schematic configuration of the transfer of ticket voucher information in association with the counting of currency and ticket vouchers in a count room of a gaming establishment.

FIG. 2 is an example configuration of a plurality of different components employed in association with the present disclosure operating to flag, for subsequent review, a clearing of a non-volatile memory of an electronic gaming machine by gaming establishment personnel servicing the electronic gaming machine.

FIG. 3 is an example configuration of a plurality of different components employed in association with the present disclosure operating to flag, for subsequent review, a ticket voucher issued by an electronic gaming machine in association with gaming establishment personnel servicing the electronic gaming machine.

FIG. 4 is an example configuration of a plurality of different components employed in association with the present disclosure operating to flag a deposit of manufactured funds added to an electronic gaming machine in association with gaming establishment personnel servicing the electronic gaming machine.

FIG. 5 is an example configuration of a plurality of different components employed in association with the present disclosure operating to limit the redemption options of a ticket voucher issued by an electronic gaming machine in association with gaming establishment personnel servicing the electronic gaming machine.

### DETAILED DESCRIPTION

In various embodiments, the systems and methods of the present disclosure track funds processed at a gaming establishment device in association with a servicing of the gaming establishment device and employ such tracking to detect potential fraudulent behavior by gaming establishment personnel.

In certain embodiments, the system of the present disclosure tracks one or more events occurring based on gaming establishment personnel interacting with a gaming establishment device, such as an electronic gaming machine (“EGM”) or a ticket voucher kiosk. In certain embodiments, the system tracks instances of when gaming establishment personnel clear one or more meters maintained by a gaming establishment device, such as when gaming establishment personnel clear a non-volatile memory of an EGM which results in clearing one or more meters that tracks funds received by the EGM. In certain embodiments, the system additionally or alternatively tracks instances of when ticket vouchers associated with an amount of funds are issued in association with gaming establishment personnel interacting with a gaming establishment device. In certain embodiments, the system additionally or alternatively tracks instances of when funds are received by a gaming establishment device in association with gaming establishment personnel interacting with the gaming establishment device. In certain embodiments, the system additionally or alternatively tracks instances of when funds are received by a gaming establishment device followed by a ticket voucher associated with such funds being issued in association with gaming establishment personnel interacting with the gaming establishment device. In these different embodiments, while such tracked events may occur (and be expected to occur) during gaming establishment personnel interacting with one or more gaming establishment devices, in certain instances, these tracked events may be indicative of potential embezzlement activities by gaming establishment personnel. Accordingly, since certain events have historically been affiliated with certain malicious behavior by gaming establishment personnel, the system of the present disclosure tracks one or more occurrences of such events which may warrant further investigation.

Specifically, while gaming establishment regulators and gaming establishment equipment providers have introduced various security measures to make it relatively difficult for gaming establishment personnel to steal from a gaming establishment, certain malicious gaming establishment personnel frequently attempt to overcome these security measures with an aim of embezzling funds from the gaming establishment. For example, while gaming establishments have implemented an accounting audit process in which a gaming establishment device management system (e.g., a slot accounting system) periodically reads one or more meters from various gaming establishment devices (e.g., EGMs on a casino floor) and compares those meters to the actual cash obtained from the gaming establishment devices during an audit/drop process, certain gaming establishment personnel utilize gaps in this process to embezzle gaming establishment funds. In view of these security gaps and the activities undertaken by gaming establishment personnel to take advantage of these security gaps, the system of the present disclosure tracks certain activities associated with potential embezzlements and utilizes such tracked activities to take zero, one or more preventive actions to combat the security concerns.

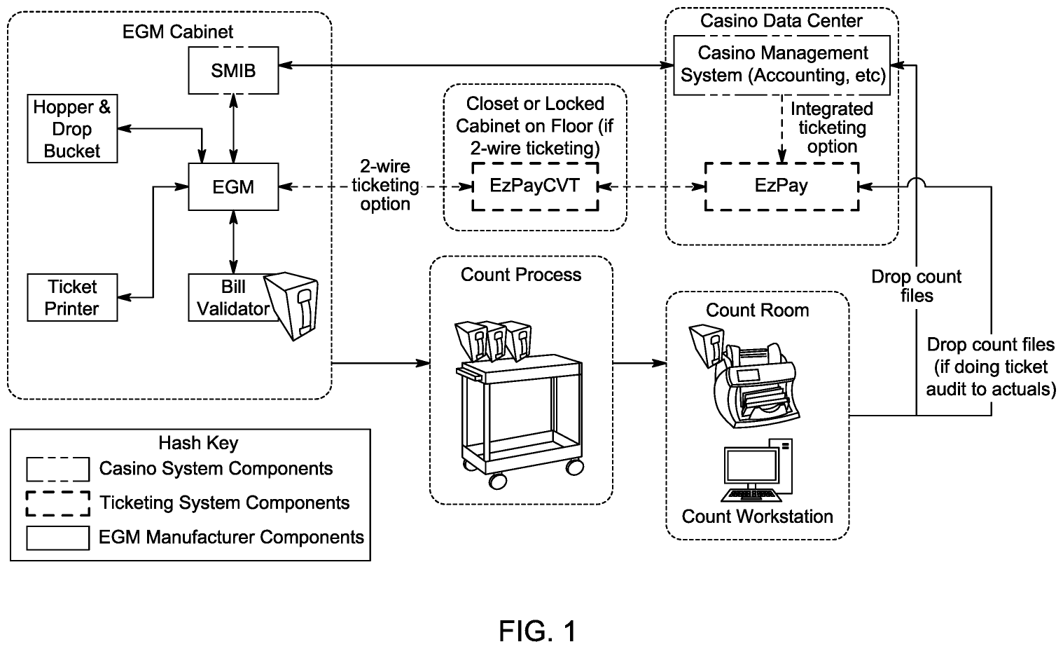

More specifically, as illustrated in FIG. 1, an audit/drop process at a gaming establishment, such as a casino, begins by having a “drop team” (i.e., one or more gaming establishment personnel whom are typically accompanied by security) go to each EGM on the gaming establishment floor, open the main door of the EGM and collect the bill validator's drop box (i.e., a secure tamper resistant container in which currency, gaming vouchers, coupons and Board-approved instruments inserted into the bill validator are deposited) and any hopper or other device used to collect any inserted physical coins inside the EGM. The “drop team” replaces the collected drop box with an empty drop box (and any collected hopper with an empty hopper). At the same time, when the main door of the EGM is opened to collect the drop box, the gaming establishment device management system (e.g., a slot accounting system) operates with the EGM to snapshot, over a Slot Accounting System (“SAS”) protocol, a Game to System (“G2S”) protocol, or any other appropriate EGM-to-system protocol, various meters maintained by the EGM.

As further seen in FIG. 1, once the bill validator drop boxes and hoppers across the gaming establishment floor have been collected, the collected bill validator drop boxes and hoppers are taken to the gaming establishment's count room which is responsible for counting the physical forms of currency and physical ticket vouchers associated with forms of currency obtained from each EGM. In the case of physical forms of currency, such as bills, personnel in the count room use automated counting machines to track the dollar amount collected from each EGM in each denomination (# of $20 bills, # of $10 bills, etc). In the case of physical tickets, personnel in the count room track the amount of each ticket and the validation number. Information from the count process is exported to one or more files and then transferred to the gaming establishment device management system, such as the slot accounting system, for further analysis.

Following the collection of data from the EGMs by the gaming establishment device management system and the transfer of information from the count process to the gaming establishment device management system, the gaming establishment device management system compares meter movement between drops to the amount of physical forms of currency and physical ticket vouchers obtained from the bill validator's drop box as determined by the count room. This comparison is then utilized by the gaming establishment and/or certain regulators to determine if any discrepancies or variances exist (which may or may not be indicative of gaming establishment personnel improperly skimming or stealing money).

In certain instances, if one or more discrepancies or variances are discovered during the audit/drop process between the gaming establishment device management system collected data from the EGMs and the information determined from the count process, such variances are investigated to determine if the variance leads to further actions and/or adjustments to the audit/drop process or if the variance is the result of legitimate circumstances. For example, if gaming establishment personnel cause an EGM to clear a non-volatile memory during a routine service call, since the clearing of the non-volatile memory causes one or more reported meters of the EGM to rollback or otherwise return to a value of zero, the clearing of the non-volatile memory triggers an audit variance in the slot accounting system which may warrant further investigation.

Since various discrepancies or variances between meter data collected from a gaming establishment device and data determined from the count process are often the result of legitimate circumstances, certain malicious gaming establishment personnel may aim to take advantage of these discrepancies perceived as being the result of legitimate circumstances to avoid the investigations of gaming establishment accountants and/or certain authorities. For example, since gaming establishment accounting staff are used to dealing with variances in meters in comparison to amounts obtained from a drop process if the EGM's non-volatile memory was reset, and since gaming establishment accounting staff usually manually intervene and update the meters recorded in the system to match the activity that occurred during the drop process, certain malicious individuals have taken advantage of this tendency and been successful. In one such occurrence, a malicious slot technician pretended that an EGM needed servicing on a casino floor and proceed to open/unlock the door of the EGM. While any accompanying security were distracted, the malicious slot technician manipulated or otherwise hacked the EGM interface to the payment acceptor (or hacked the payment acceptor directly) such that the EGM incorrectly detected monetary funds were being inserted into the EGM. This resulted in the EGM's credit meter incrementing based upon the detection of these fake funds being inserted. The malicious slot technician then cashed out the funds on the EGM's credit meter to obtain a ticket voucher (e.g., an anonymous bearer instrument associated with an amount of funds and redeemable for cash via a kiosk, a cashier and/or game play on a gaming establishment device, such as an EGM). To avoid detection of their actions and before closing the EGM, the malicious slot technician cleared the non-volatile memory of the EGM and thus removed any history of the fake funds being inserted. The malicious slot technician who received the ticket voucher would pass that ticket voucher to a co-conspirator who later returned to the casino and redeemed the ticket voucher for cash.

As mentioned above, while the clearing of the non-volatile memory and the resulting resetting of the EGM's reported meters to zero caused a variance on that EGM during a subsequent audit/drop process, gaming establishment accounting staff's frequent manual intervention to update the reported meters of the EGM recorded in the system to match the activity that occurred during the audit/drop process resulted in the embezzlement activities of the malicious slot technician going undetected.

In view of these prior, successful embezzlements of funds from an EGM which relied on accounting staff's frequent exposure to and, at times, manual intervention to override instances of the rolling back of one or more meters of the EGM, when the system of the present disclosure determines that one or more tracked events may be indicative of one or more attempts to embezzle funds from one or more gaming establishment devices, such as EGMs, the system undertakes one or more actions to counteract these potential attempts at embezzling funds. That is, since certain tracked events may or may not be associated with potential embezzlement activities by gaming establishment personnel, responsive to one or more occurrences of such tracked events, the system takes zero, one or more prohibit measures to minimize (or eliminate) these potential embezzlement activities. In certain embodiments, based on one or more of the tracked events, the system places one or more restrictions on future interactions gaming establishment personnel may have with the gaming establishment device. In certain embodiment, based on one or more of these tracked events, the system additionally or alternatively places one or more restrictions on any ticket vouchers issued in association with these tracked events. In certain embodiment, based on one or more of these tracked events, the system additionally or alternatively places one or more restrictions on any funds associated with ticket vouchers issued in association with these tracked events. These actions, individually and/or collectively contribute to a reduction in potential embezzlement activities by gaming establishment personnel.

In various embodiments, the system includes (or is otherwise in communication with) various components or sub-systems operating together to determine if certain activities undertaken by gaming establishment personnel (or the lack of certain activities) are indicative of certain potentially fraudulent behaviors and if so, take zero, one or more preventative actions to minimize or deter such potential fraudulent behavior.

In certain embodiments, the system is in communication with one or more gaming establishment devices, such as one or more ticket voucher redemption kiosks that are operable to receive a ticket voucher and dispense an amount of currency; and/or one or more EGMs, (e.g., a slot machine, a video poker machine, a video lottery terminal, a terminal associated with an electronic table game, a terminal associated with a live table game, a video keno machine, a video bingo machine, a historical horse racing terminal and/or a sports betting terminal (offering sports betting opportunities and, in certain instances, wagering games)), that are operable to receive an amount of currency and/or a ticket voucher for an increase of a credit balance of the EGM and/or issue a ticket voucher for an amount corresponding to a cashed out credit balance of the EGM.

In certain embodiments, the system is in communication with a distinct and independently operating gaming establishment device management system. In certain embodiments, the system includes a gaming establishment device management system. In these different embodiments, the gaming establishment device management system includes one or more servers which interface with one or more gaming establishment devices to receive data associated with the activities occurring at the gaming establishment device. In certain embodiments, the data includes accounting data and the gaming establishment device management system operates as part of an accounting system. In certain embodiments, the data additionally or alternatively includes gaming establishment device state data and the gaming establishment device management system operates as part of casino floor management system.

In certain embodiments, the system is in communication with a distinct and independently operating gaming establishment ticket voucher system. In certain embodiments, the system includes a gaming establishment ticket voucher system. In these different embodiments, the gaming establishment ticket voucher system includes one or more servers which store, in one or more databases, ticket voucher identification information associated with each ticket voucher created by the ticket voucher system, such as identifying information, value information, and/or activity information. In certain embodiments, each ticket voucher includes or is otherwise associated with different identifying information which is identifiable to a holder of the ticket voucher, such as a ticket voucher validation number, and an amount of funds associated with the ticket voucher. In different embodiments, the ticket voucher database and/or the ticket voucher includes or is otherwise associated with various fields of ticket voucher identifying information including, but not limited to: (i) a primary key (i.e., an index for a record in a table); (ii) a ticket voucher validation number (i.e., the validation number associated with the issued ticket); (iii) a ticket state (e.g., a state of a ticket as being in an issued state, a redeemed state and/or a potentially illegal ticket voucher state); (iv) an issuance date/time (i.e., the date/time when the ticket voucher was issued); (v) a property address associated with the ticket voucher issuance; (vi) an amount of funds associated with the ticket voucher; (vii) any expiration date associated with the ticket voucher; (viii) a device identification associated with the issuance of the ticket voucher; (ix) an image of the ticket voucher (e.g., an image of a front of the ticket voucher and/or an image of a back of the ticket voucher); (x) any redemption date (i.e., the date the ticket voucher was redeemed at (if the ticket voucher is in the redeemed state)); (xi) redeemed at (i.e., the device where the ticket voucher was redeemed (if the ticket voucher is in the redeemed state)); (xii) a data signature (i.e., a signature of the data associated with the ticket voucher to prevent tampering by casino employees); (xiii) a machine identification (i.e., an asset or machine number of the device that printed the ticket voucher); (xiv) a state or mode of operation of the device that issued the ticket voucher when the ticket voucher was issued (i.e., a game play mode of operation or a service mode of operation); (xv) any gaming establishment personnel associated with the issuance of the ticket voucher; and/or (xvi) any redemption limitations associated with the issued ticket voucher.

In addition to maintaining information associated with each ticket voucher, in certain embodiments wherein the ticket voucher takes the form of a paper ticket voucher, the ticket voucher system includes one or more ticket voucher system components, such as a ticket voucher printer configured to print paper ticket vouchers and/or a ticket voucher acceptor configured to receive paper ticket vouchers. For example, a ticket voucher printer is associated with a gaming establishment device that prints ticket vouchers. In certain other embodiments wherein a ticket voucher takes the form of a virtual ticket voucher, the ticket voucher system includes one or more interfaces operable to communicate, to a mobile device, data associated with a virtual ticket voucher. It should be appreciated that in different embodiments, the system utilizes a mobile device running a mobile device application, a kiosk, a gaming establishment device (e.g., an EGM), an externally controlled interface (e.g., a service window displayed by an EGM or by a display device associated with a slot machine interface board (“SMIB”)), and/or a gaming establishment interface, such as a casino desk, to interface with one or more users to facilitate interactions with the system and/or the ticket voucher system.

In various embodiments, to track activities of gaming establishment personnel relative to a gaming establishment device and/or track events that occur at a gaming establishment device during a period of time associated with gaming establishment personnel, the system first provides gaming establishment personnel access to the gaming establishment device. In these embodiments, to provide such access, the system enables the gaming establishment personnel (e.g., an EGM technician or operator) to attempt to log into a gaming establishment device management system using a gaming establishment personnel identification device.

In certain embodiments, the gaming establishment personnel identification device includes a physical instrument, such as a magnetic striped card, issued to the gaming establishment personnel and associated with an account of the gaming establishment personnel. In these embodiments, the system enables the gaming establishment personnel to use such a physical instrument associated with a gaming establishment personnel account to attempt to log into the gaming establishment device management system, such as a slot accounting system, which is configured to track activities of the gaming establishment personnel and associate gaming establishment personnel identification information stored in association with the gaming establishment personnel account with certain activities.

In various embodiments, the gaming establishment personnel identification device includes a mobile device executing a gaming establishment personnel mobile device application. In these embodiments, the system enables the gaming establishment personnel to use a mobile device executing a mobile device application associated with a gaming establishment personnel account to attempt to log into the gaming establishment device management system, such as a slot accounting system, which is configured to track activities of the gaming establishment personnel and associate gaming establishment personnel identification information stored in association with the gaming establishment personnel account with certain activities. In these embodiments, the system enables such logging into the gaming establishment device management system using the mobile device application of the mobile device without using a physical instrument, such as a magnetic striped card, issued to the gaming establishment personnel and associated with the gaming establishment personnel account.

In certain embodiments wherein the system enables a gaming establishment personnel to attempt to log into a gaming establishment device management system using a mobile device executing a mobile device application, following the launching of a gaming establishment personnel mobile device application and any requirement of the gaming establishment personnel logging into the gaming establishment personnel mobile device application, the gaming establishment personnel mobile device application prompts the gaming establishment personnel to cause the gaming establishment personnel mobile device to engage the EGM (e.g., the gaming establishment personnel taps the mobile device to a player tracking card reader or other designated location(s) of the EGM). After such engagement (or after the launching of the gaming establishment personnel mobile device application if no gaming establishment personnel mobile device engagement is required), the gaming establishment personnel mobile device application attempts to pair with the EGM by communicating, via one or more wireless communication protocols (including, but not limited to: Bluetooth™, Bluetooth Low Energy (“BLE”), one or more cellular communication standards (e.g., 3G, 4G, 5G, 6G, LTE), one or more Wi-Fi compatible standards, and one or more short range communication protocols (e.g., a near field communication (“NFC”) protocol), data associated with the gaming establishment personnel, such as a gaming establishment personnel identifier (e.g., a maintenance identifier) stored by the gaming establishment personnel mobile device, to the EGM and/or a component of a gaming establishment device management system supported by the EGM, such as a SMIB associated with the EGM. In one such embodiment, the gaming establishment personnel mobile device application communicates data to an antenna, such as a BLE antenna, which interfaces with the card reader of the player tracking unit associated with the EGM that interfaces with the SMIB in communication with the gaming establishment device management system.

In certain embodiments, following the receipt of data associated with the gaming establishment personnel identification device, such as following receipt of a gaming establishment personnel's employee card number, the EGM (and/or the SMIB) attempts to validate the gaming establishment personnel identifier provided by the gaming establishment personnel identification device. For example, following the receipt of a gaming establishment personnel identifier from a gaming establishment personnel mobile device, the EGM (and/or the SMIB) operates with a server of a gaming establishment personnel management system (and/or the gaming establishment device management system) to verify that the gaming establishment personnel identifier associated with the gaming establishment personnel mobile device is authentic.

If the EGM (and/or the SMIB) is unable to validate the gaming establishment personnel identification device provided by the gaming establishment personnel, the system prevents the gaming establishment personnel from logging into the EGM (and/or any component associated with the EGM). For example, if the server of the gaming establishment personnel management system notifies the EGM that the gaming establishment personnel identifier is no longer valid because the gaming establishment personnel assigned that gaming establishment personnel identifier is no longer employed by the gaming establishment, the EGM prevents such former gaming establishment personnel from logging into the EGM and accessing any controls of the EGM. Without logging into the EGM, if an individual opens the door of the EGM, the EGM will detect this occurrence and notify the gaming establishment device management system of the potential security threat at that EGM (e.g., an unknown, or unexpected opening of the door's of an EGM). In certain instances, security will be dispatched immediately to investigate such an occurrence.

On the other hand, if the EGM (and/or the SMIB) validates the gaming establishment personnel identification device provided by the gaming establishment personnel, the system logs the gaming establishment personnel into the EGM and enables the gaming establishment personnel to take one or more actions. For example, if the server of the gaming establishment personnel management system (and/or gaming establishment device management system) notifies the EGM that the provided gaming establishment personnel identification device is valid, the EGM (and/or the SMIB) enables actions to be undertaken by the gaming establishment personnel, such as performing maintenance of the EGM which may include clearing a non-volatile memory of the EGM. It should be appreciated that following the gaming establishment personnel identifying themselves and being logged into an EGM, if the gaming establishment personnel then opens the door of the EGM, the gaming establishment device management system will learn about the EGM's door being opened and treat it as an expected occurrence or event.

In certain embodiments, upon a determination that the provided gaming establishment personnel identification device is valid, the system enables the gaming establishment personnel to log into the EGM (and/or a component associated with the EGM, such as the SMIB) and obtain information associated with the EGM, such as a log of tracked events that occurred at the EGM. In certain embodiments, the system additionally or alternatively enables the gaming establishment personnel to log into the EGM (and/or a component associated with the EGM, such as the SMIB) and obtain information associated with one or more players, such as a player account number associated with a player that recently logged into the EGM. In certain embodiments, the system additionally or alternatively enables the gaming establishment personnel to log into the EGM (and/or a component associated with the EGM, such as the SMIB) and obtain information independent of the EGM and the player. In these embodiments, upon the gaming establishment personnel using a gaming establishment personnel identification device to log into the EGM (and/or the SMIB), the EGM (and/or the SMIB) alters how it operates to display certain information to the gaming establishment personnel not otherwise available to be displayed prior to the gaming establishment personnel logging into the EGM (and/or the SMIB).

In certain embodiments, upon a determination that the provided gaming establishment personnel identification device is valid, the system enables the gaming establishment personnel to log into the EGM (and/or a component associated with the EGM, such as the SMIB) and intervene with the operation of the EGM. In these embodiments, in addition to or alternative from obtaining information associated with the EGM, the system enables the gaming establishment personnel to interface with the EGM (and/or the SMIB) to access one or more features or operations not otherwise available to a player. In certain embodiments, the system enables the gaming establishment personnel to interface directly with the EGM (and/or the SMIB) by making one or more inputs utilizing an input device of the EGM (and/or an input device associated with the SMIB). In certain embodiments, the system additionally or alternatively enables the gaming establishment personnel to interface with the EGM (and/or the SMIB) by making one or more inputs utilizing a gaming establishment personnel mobile device application wherein data associated with such inputs is communicated to the EGM (and/or the SMIB) and/or another component of the system of the present disclosure. In certain of these embodiments, following a gaming establishment personnel successfully logging into the EGM (and/or the SMIB), the EGM (and/or the SMIB) switches from a game play mode of operation to a service mode of operation (e.g., a gaming establishment personnel mode of operation) in which the gaming establishment personnel may modify the EGM (and/or the SMIB) and the actions undertaken by the gaming establishment personnel are tracked in accordance with the present disclosure.

In certain embodiments, upon logging into the EGM (and/or the SMIB), the gaming establishment personnel undertakes one or more actions to resolve an issue with the EGM (and/or the SMIB) associated with a gaming establishment personnel intervention event that occurred. That is, the gaming establishment personnel interfaces with the one or more components of the system of the present disclosure to make zero, one or more inputs to perform zero, one or more actions in an attempt to address the circumstances that caused a gaming establishment personnel intervention event to occur. In certain embodiments, a gaming establishment personnel intervention event includes a gaming establishment personnel scheduled access of the EGM, such as to empty a cashbox of the EGM. In certain embodiments, a gaming establishment personnel intervention event includes the EGM being in a state or condition that requires gaming establishment personnel to intervene. In one such embodiment, a gaming establishment personnel intervention event includes a handpay lockup event wherein when an award amount associated with a game outcome obtained during a play of a game at the EGM, such as a jackpot award that exceeds the jurisdictional handpay limit, causes the EGM to lock up awaiting gaming establishment personnel intervention. In another such embodiment, a gaming establishment personnel intervention event includes an error event, such as when a printer of the EGM is out of paper or a bill acceptor of the EGM is jammed, wherein gaming establishment personnel are required to service the EGM and cure the error. In certain embodiments, a gaming establishment personnel intervention event includes a player requesting gaming establishment personnel to intervene. In one such embodiment, a gaming establishment personnel intervention event includes a player disputing an outcome and/or award obtained during a play of a game at the EGM wherein the player has made one or more inputs, such as requesting service through a remote host controlled service window displayed by the EGM, to dispute an outcome and/or award. In another such embodiment, a gaming establishment personnel intervention event includes a player pressing a service button, wherein, in certain instances, such an input operates to open/close a service window (i.e., a remote host controlled interface displayed by the EGM). In certain embodiments, a gaming establishment personnel intervention event includes gaming establishment personnel making one or more inputs (at the EGM and/or remote from the EGM) to intervene. It should be appreciated that any suitable event associated with a player at an EGM, independent of the player at the EGM, associated with a gaming establishment personnel, independent of a gaming establishment personnel, associated with a state of the EGM and/or independent of the state of the EGM may be employed that results in the gaming establishment personnel interfacing with the EGM.

In various embodiments, following the gaming establishment personnel logging into the EGM (and/or the SMIB) to resolve an issue associated with a gaming establishment personnel intervention event that occurred or independent of any occurrence of any gaming establishment personnel intervention event, the system tracks certain events that occur before, during and/or after a period of time when the gaming establishment personnel is logged into the EGM (and/or the SMIB) and, in certain instances, takes certain preventative measures to reduce (or eliminate) frauds committed by gaming establishment personnel that take advantage of their access to the EGM.

In certain embodiments, the tracked event associated with gaming establishment personnel includes a clearing of the EGM's non-volatile memory, such as a clearing of NVRAM of the EGM. In these embodiments, when an EGM's non-volatile memory is cleared, the EGM (and/or the SMIB) reports such an event to one or more systems. For example, in the SAS protocol, the EGM reports one or more events to the system (called “exceptions”) depending upon the details of how non-volatile memory was cleared (e.g., the EGM may generate a SAS exception 0x32 “Critical data memory error”). In another example, in GSA's G2S protocol, the EGM publishes the G2S_CBE311 “Non-Volatile Storage Fault” event. In certain embodiments, in addition to or alternative from the EGM (and/or SMIB) reporting such a non-volatile memory clearing event, the system detects the occurrence of the EGM's meters going backwards by comparing the reported meters to those last read by the system. In such an instance, the system notes an exception or an event to subsequently aid gaming establishment staff in potentially validating the variance created by the occurrence of a non-volatile memory clearance or fault event.

In certain embodiments, in addition to reporting and/or detecting when an EGM's non-volatile memory is cleared, the system associates the occurrences of such events with the gaming establishment personnel (e.g., EGM technician or operator) who is either at that EGM or was previously at that EGM within some reasonable time interval, such as a time period that begins when the gaming establishment personnel logged into the EGM and ends when game play occurs at the EGM (or ends when a player or another member of gaming establishment personnel log into the EGM). For example, if Robert is a gaming establishment staff member who services an EGM, and during that process of servicing the EGM, Robert clears the non-volatile memory of the EGM, the system will associate that clearance/non-volatile memory fault event with Robert. Such information will be recorded by the system, such as by the gaming establishment device management system (and/or a component that interfaces with the gaming establishment device management system) and associated with Robert.

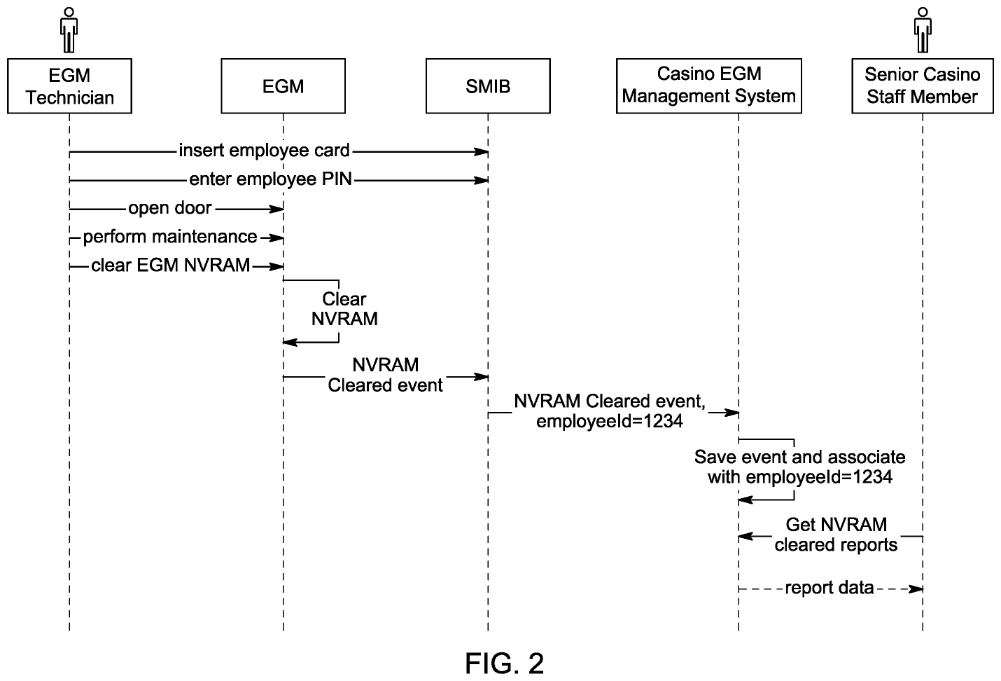

In certain embodiments, the system employs such information and associations with one or more members of gaming establishment personnel to generate one or more reports on how many non-volatile memory and/or non-volatile memory clearance events are associated with certain members of gaming establishment personnel. These reports enable the gaming establishment management to invoke one or more internal processes to evaluate the report and potentially identify gaming establishment personnel who are associated with excessive amounts of non-volatile memory faults or non-volatile memory clearance events. For example, as seen in FIG. 2 (which illustrates the described interactions between an EGM technician, an EGM, a component of a gaming establishment device management system associated with the EGM, the gaming establishment device management system and gaming establishment management personnel), following an EGM technician logging into an EGM via interacting with a SMIB (i.e., a component of a gaming establishment device management system associated with the EGM) and the EGM technician clearing a non-volatile memory of the EGM, such an occurrence of a cleared non-volatile memory of the EGM is communicated to the casino EGM management system (i.e., the gaming establishment device management system) which employs such information to create a report of cleared non-volatile memory events associated with the EGM technician for a senior casino staff member (i.e., gaming establishment management) to review. In certain embodiments, the created report includes historic non-volatile memory clearing activity associated with an individual EGM technician, or across numerous EGM technicians over a selectable period of time.

In certain embodiments, the system employs one or more rules to help identify potential gaming establishment personnel who may have more non-volatile memory clears than are reasonably expected. In these embodiments, the system employs one or more threshold quantities of expected non-volatile memory clearing events (which may be different for different gaming establishment personnel of different levels, different experience and tasked with different responsibilities) and determines, for each individual gaming establishment personnel, whether the tracked quantity of non-volatile memory clearing events associated with that individual reaches the threshold quantity of expected non-volatile clearing events for that individual. In certain such embodiments, the system employs artificial intelligence and/or machine learning to train a model to determine one or more threshold quantities of expected non-volatile memory clearing events and determines whether the tracked quantity of non-volatile memory clearing events reaches the model determined threshold quantity of expected non-volatile clearing events. In certain embodiments, the system enables an operator to set one or more rules regarding tracking occurrences of non-volatile memory clears. In certain embodiments, one or more rules regarding tracking occurrences of non-volatile memory clears are hard-coded into the system. In certain embodiments, the system employs a dynamic threshold of expected non-volatile memory clearing events. In these embodiments, the system compares different gaming establishment personnel against each other to determine (and alert appropriate gaming establishment accounting staff and/or gaming establishment security staff if warranted) which gaming establishment personnel might be responsible for abnormally high EGM non-volatile memory clearing events and/or EGM non-volatile memory fault events.

In certain embodiments, the tracked event associated with gaming establishment personnel includes the printing of ticket vouchers by gaming establishment personnel in association with interfacing with an EGM. In certain embodiments, the system generates a custom event, such as a potentially illegal ticket voucher printed event that is noted whenever a ticket voucher is issued during (or otherwise in association with) a servicing process of an EGM. In one embodiment, since the EGM will not permit gaming establishment personnel to print a ticket voucher while the EGM's main door is open, if gaming establishment personnel close the main door and causes the EGM to print a ticket voucher, such as by adjusting the settings on the door switches so that the EGM wrongly determines that the main door is closed (when it is actually open) and enables a ticket voucher to be printed, the system detects the printing of a ticket voucher by tagging the printing of the ticket voucher in association with the member of gaming establishment personnel being logged into the EGM. In another embodiment, the system additionally or alternatively detects the printing of such a potentially illegal ticket voucher by an EGM printing a ticket voucher immediately following a door close event without any intervening game play.

In certain embodiments, in addition to reporting and/or detecting when such a potentially illegal ticket voucher is printed by an EGM, the system associates the occurrences of such events with the gaming establishment personnel (e.g., EGM technician or operator) who is either at that EGM or was previously at that EGM with a reasonable time interval. In certain embodiments, in addition to noting the occurrence of the potentially illegal ticket voucher printed event and associating such an event with a member of gaming establishment personnel, the system designates (or operates with the ticket voucher system to designate) the issued ticket voucher (in paper or virtual form) as a potentially illegal printed ticket voucher.

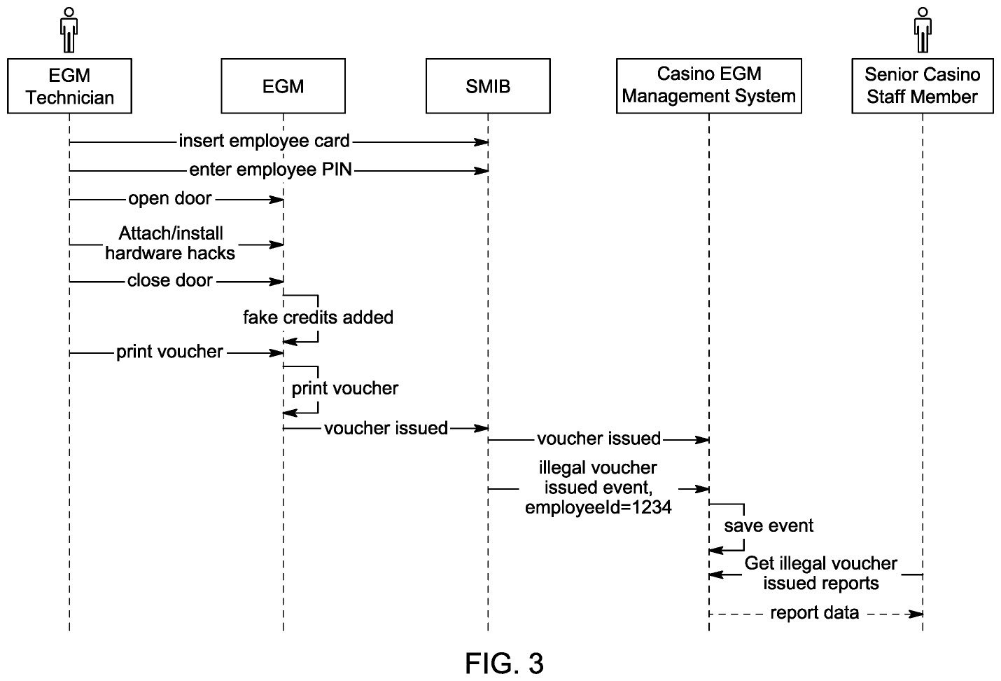

In certain embodiments, the system employs the information and associations of the potentially illegal printed ticket voucher with one or more EGM technicians to generate one or more reports on how many potentially illegal ticket voucher printing events are associated with certain members of gaming establishment personnel. These reports enable the gaming establishment management to invoke one or more internal processes to evaluate the report and potentially identify EGM technicians who are associated with excessive amounts of ticket vouchers while allegedly servicing EGMs. For example, as seen in FIG. 3 (which illustrates the described interactions between an EGM technician, an EGM, a component of a gaming establishment device management system associated with the EGM, the gaming establishment device management system and gaming establishment management personnel), following an EGM technician logging into an EGM via interacting with a SMIB (i.e., a component of a gaming establishment device management system associated with the EGM) and the EGM technician printing a ticket voucher associated with manufactured funds (i.e., fake funds) added to the EGM, such an occurrence of an issuance of a potentially illegal ticket voucher is communicated to the casino EGM management system (i.e., the gaming establishment device management system) which employs such information to create a report of potentially illegal ticket vouchers issued associated with the EGM technician for a senior casino staff member (i.e., gaming establishment management) to review. In certain embodiments, the created report includes historic ticket voucher printing activity associated with an individual EGM technician, or across numerous EGM technicians over a selectable period of time.

In certain embodiments, the system employs one or more rules to help identify potential gaming establishment personnel who may have more ticket vouchers issued than are reasonably expected. In these embodiments, the system employs one or more threshold quantities of expected ticket vouchers (which may be different for different gaming establishment personnel of different levels, different experience and tasked with different responsibilities) and determines, for each individual gaming establishment personnel, whether the tracked quantity of issued ticket vouchers associated with that individual reaches the threshold quantity of expected issued ticket vouchers for that individual. In certain such embodiments, the system employs artificial intelligence and/or machine learning to train a model to determine one or more threshold quantities of expected issued ticket vouchers and determines whether the tracked quantity of issued ticket vouchers reaches the model determined threshold quantity of expected issued ticket vouchers. In certain embodiments, the system enables an operator to set one or more rules regarding tracking occurrences of ticket vouchers issued. In certain embodiments, one or more rules regarding tracking occurrences of ticket vouchers issued are hard-coded into the system. In certain embodiments, the system employs a dynamic threshold of expected ticket vouchers issued. In these embodiments, the system compares different gaming establishment personnel against each other to determine (and alert appropriate gaming establishment accounting staff and/or gaming establishment security staff if warranted) which gaming establishment personnel might be responsible for abnormally high ticket vouchers issued.

In certain embodiments, the tracked event associated with gaming establishment personnel includes the deposit of funds by gaming establishment personnel in association with interfacing with an EGM. In certain embodiments, the system generates a custom event, such as a potentially illegal cash insertion event whenever an amount of currency is deposited or otherwise inserted into the EGM during (or otherwise in association with) a servicing process of an EGM. In certain embodiments, the system generates a custom event, such as a potentially illegal ticket voucher insertion event whenever a ticket voucher (in paper or virtual form) is deposited or otherwise inserted into the EGM during (or otherwise in association with) a servicing process of an EGM.

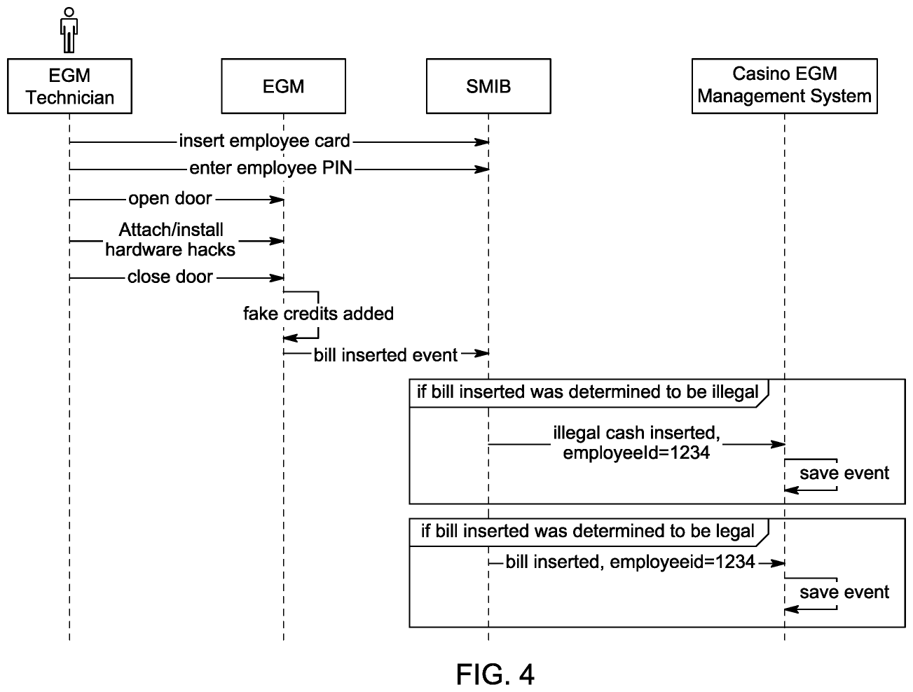

In one embodiment, since the EGM will not permit gaming establishment personnel to deposit currency or a ticket voucher while the EGM's main door is open because the bill validator is disabled, if gaming establishment personnel close the main door and inserts currency or a ticket voucher into the EGM, such as by adjusting the settings on the door switches so that the EGM wrongly determines that the main door is closed (when it is actually open) and inserting currency and/or a ticket voucher, the system detects such a deposit of funds by tagging the fund deposit in association with the member of gaming establishment personnel being logged into the EGM. In another embodiment, the system additionally or alternatively detects the deposit of funds after gaming establishment personnel have logged off the EGM but prior to an expiration of a timer. In these embodiments, if the system determines the occurrence of such a deposit of funds in association with gaming establishment personnel, the system generates one or more custom events (e.g., the potentially illegal cash insertion event and/or the potentially illegal ticket voucher insertion event) and associates that event with the applicable member of gaming establishment personnel. For example, as seen in FIG. 4 (which illustrates the described interactions between an EGM technician, an EGM, a component of a gaming establishment device management system associated with the EGM, and the gaming establishment device management system), following an EGM technician logging into an EGM via interacting with a SMIB (i.e., a component of a gaming establishment device management system associated with the EGM) and the EGM technician depositing a ticket voucher, such an occurrence of the insertion of the ticket voucher is communicated to the casino EGM management system (i.e., the gaming establishment device management system) to save such events in association with the EGM technician servicing the EGM.

In certain embodiments, the system employs this information and associations with one or more EGM technicians to generate one or more reports on how many fund deposit events are associated with certain members of gaming establishment personnel. These reports enable the gaming establishment management to invoke one or more internal processes to evaluate the report and potentially identify EGM technicians who are associated with excessive amounts of fund deposits while allegedly servicing EGMs. In certain embodiments, the created report includes historic fund deposit activity associated with an individual EGM technician, or across numerous EGM technicians over a selectable period of time.

In certain embodiments, the system employs one or more rules to help identify any gaming establishment personnel who may have more fund deposits (in quantity and/or amounts) while servicing an EGM than are reasonably expected. In these embodiments, the system employs one or more threshold quantities of expected fund deposits (which may be different for different gaming establishment personnel of different levels, different experience and tasked with different responsibilities) and determines, for each individual gaming establishment personnel, whether the tracked quantity of funds deposits associated with that individual reaches the threshold quantity of expected fund deposits for that individual. In certain such embodiments, the system employs artificial intelligence and/or machine learning to train a model to determine one or more threshold quantities of expected fund deposits and determines whether the tracked quantity of fund deposits reaches the model determined threshold quantity of expected fund deposits. In certain embodiments, the system enables an operator to set one or more rules regarding tracking occurrences of funds deposited by gaming establishment personnel. In certain embodiments, one or more rules regarding tracking occurrences of fund deposits by gaming establishment personnel are hard-coded into the system. In certain embodiments, the system employs a dynamic threshold of expected fund deposits. In these embodiments, the system compares different gaming establishment personnel against each other to determine (and alert appropriate gaming establishment accounting staff and/or gaming establishment security staff if warranted) which gaming establishment personnel might be responsible for abnormally high fund deposits (in quantity and/or amount) over a tracked period of time.

In certain embodiments, the tracked event associated with gaming establishment personnel includes the deposit of funds by gaming establishment personnel in association with interfacing with an EGM followed by the printing of ticket vouchers for such deposited funds. In these embodiments, since depositing funds into an EGM and then cashing such funds out without intervening game play is one avenue by which individuals attempt to potentially launder money, the system detects these scenarios and reports them by providing the appropriate information that must be submitted with financial crimes regulators in a given jurisdiction. For example, the system generates reports associated with these potential money laundering events over a defined lookback period and enables a gaming establishment the ability to have the appropriate information to file one or more suspicious activity reports with financial crimes regulatory agencies, such as the US Treasury's FinCEN. In another such embodiment, upon detection of a suspicious financial transaction event, the system automatically fills in the appropriate regulatory agency report (e.g., Suspicious Activity Report (SAR), Currency Transaction Report (CTR)) for submission by the gaming establishment to the regulatory body. In another such embodiment, the system electronically submits the generated reports to the appropriate regulatory body.

In certain embodiments, the system detects the deposit of funds followed by the printing of a ticket voucher by tagging such events in association with the member of gaming establishment personnel logged into the EGM. For example, if an EGM technician inserts $20 of cash, then prints a ticket voucher, the SMIB can report to the gaming establishment device management system that for the recently issued voucher, $20 of the funds on that ticket voucher came from the bill validator. In certain embodiments, the system tracks the deposit of funds relative to the amount and/or timing of ticket vouchers to determine which events are deemed suspicious and may require further investigation. For example, the system determines that any ticket vouchers printed above a certain amount without corresponding wagers of a certain amount should be flagged as suspicious and may require further investigation by staff. In certain embodiments, the system utilizes one or more thresholds such that the system generates one or more alerts if a ticket voucher is issued with a certain minimum value and at least a percentage of the funds, such as 75% or more of the funds, were not previously wagered.

In certain embodiments, in addition to tracking and flagging the occurrence of one or more events that may be associated with a fraud being committed, the system of the present disclosure undertakes one or more actions to counteract certain attempts at embezzling funds from one or more gaming establishment devices, such as EGMs. That is, since certain tracked events may or may not be indicative of potential embezzlement activities by gaming establishment personnel, responsive to one or more occurrences of such tracked events, the system takes zero, one or more prohibit measures to minimize (or eliminate) these potential embezzlement activities. Such actions, individually and/or collectively contribute to a reduction in potential embezzlement activities by gaming establishment personnel.

In certain embodiments, once the system determines that a member of gaming establishment personnel is a potential risk, the system alerts appropriate personnel, such as gaming establishment accounting staff and/or gaming establishment security staff, of the activities of that member of gaming establishment personnel. In certain embodiments, appropriate personnel investigate the tracked events that caused the system to determine that the member of gaming establishment personnel is a potential risk. For example, following a determination that a particular EGM technician has deposited more ticket vouchers (in quantity and/or amount) than expected while servicing EGMs, the system alerts appropriate personnel of such deposits for further review.

In certain embodiments, once the system determines that one or more events that occurred while a member of gaming establishment personnel was interfacing with an EGM qualify as a potential risk, the system alerts appropriate personnel, such as gaming establishment accounting staff and/or gaming establishment security staff, of such events. In certain embodiments, appropriate personnel investigate the tracked events that caused the system to flag such events as a potential risk. For example, following a determination that a ticket voucher of greater than a certain amount was issued by an EGM in a service mode of operation, the system alerts appropriate personnel of such an event for further investigation.

In certain embodiments, once the system determines that one or more events that occurred while a member of gaming establishment personnel was interfacing with an EGM qualify as a potential risk, the system employs tracked information associated with these events to enhance an EGM metered-actual-audit. For example, if a member of gaming establishment personnel clears a non-volatile memory of an EGM in an effort to hide their activity at an EGM during servicing the EGM, the system employs additional data associated with this clearing event to enhance the audit/drop process. In this example, the system tracks the bills and ticket vouchers expected to be in the bill validator drop and uses this information to emphasize to a member of a gaming establishment accounting staff what is expected to be obtained from drop. Such information associated with the source of funds may potentially help the member of the gaming establishment accounting staff further understand why a variance might be occurring in the accounting system and help raise suspicion about the incident.

In certain embodiments, once the system determines that a member of gaming establishment personnel is a potential risk, the system additionally or alternatively disables that member's access to the system, such as by disabling that member's gaming establishment personnel identification device. For example, following a determination that a particular EGM technician has caused the printing of a relatively high number of ticket vouchers while servicing EGMs, the system automatically disables that EGM technician from logging into other EGMs (and/or accessing the EGM technicians account) until such incidents are investigated by appropriate gaming establishment staff. In another example, following a determination that a particular EGM technician has deposited more than an expected threshold amount of funds into EGMs while servicing EGMs, the system automatically disables that EGM technician from logging into other EGMs (and/or accessing the EGM technicians account) until such incidents are investigated by appropriate gaming establishment staff.

In certain embodiments, once the system determines that a member of gaming establishment personnel is a potential risk, the system additionally or alternatively institutes one or more restrictions on who can resolve one or more subsequently flagged issues associated with that member of gaming establishment personnel. For example, if the system determines an accounting variance associated with an EGM that was serviced by a member of gaming establishment personnel with an elevated quantity of non-volatile memory clearing events, the system restricts resolving that variance to only slot accounting managers and/or appropriate senior personnel.

In certain embodiments, the system additionally or alternatively places one or more restrictions on the redemption of any ticket vouchers caused to be printed by gaming establishment personnel and/or printed in association with one or more detected events, such as a potentially illegal ticket voucher printed event. In certain embodiments, once the system determines that a member of gaming establishment personnel is a potential risk, the system then places one or more restrictions on the redemption of any ticket vouchers caused to be printed by gaming establishment personnel and/or printed in association with one or more detected events, such as a potentially illegal ticket voucher printed event.

In certain embodiments, upon detecting that one or more ticket vouchers were printed from an EGM operating in a service mode of operating, the system will associate (or operate with a gaming establishment ticket voucher system to associate) the ticket voucher printed or issued by the EGM as a potentially illegal ticket voucher. In certain embodiments, upon detecting that one or more ticket vouchers were printed from an EGM following a deposit of funds without any intervening wagering activity, the system will associate (or operate with a gaming establishment ticket voucher system to associate) the ticket voucher printed or issued by the EGM as a potentially illegal ticket voucher.

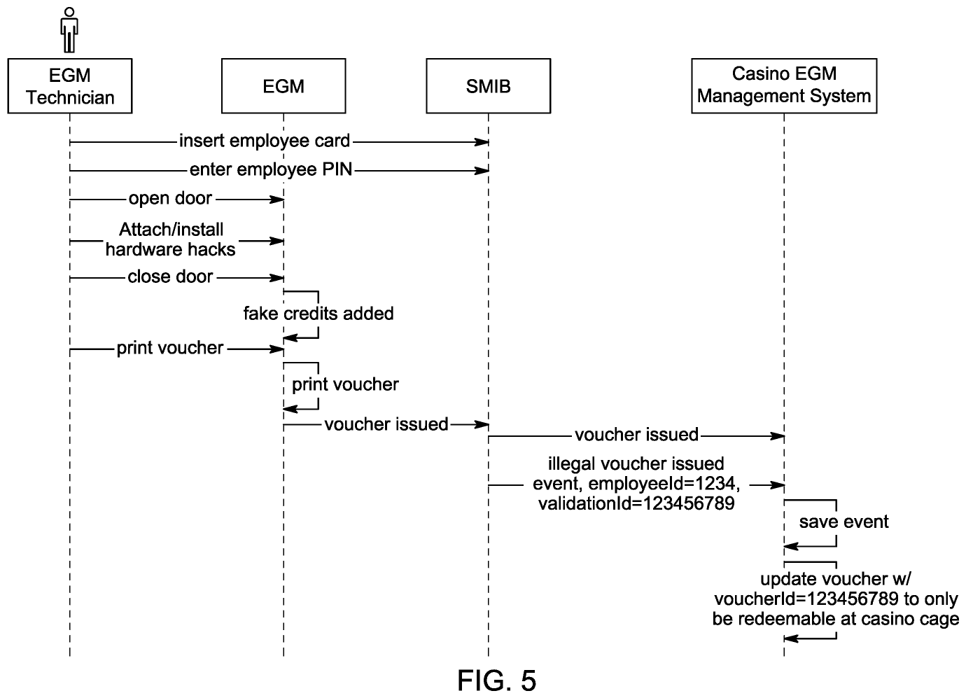

In certain embodiments, associating a ticket voucher as a potentially illegal ticket voucher includes changing the state of that ticket voucher such that the ticket voucher cannot be redeemed at any ticket voucher redemption points, but rather must be redeemed at one or more controlled ticket voucher redemption points of a gaming establishment. For example, as seen in FIG. 5 (which illustrates the described interactions between an EGM technician, an EGM, a component of a gaming establishment device management system associated with the EGM, and the gaming establishment device management system), following an EGM technician logging into an EGM via interacting with a SMIB (i.e., a component of a gaming establishment device management system associated with the EGM) and the EGM technician causing the EGM to print a ticket voucher associated with manufactured funds (i.e., fake funds) added to the EGM, the issuance of the ticket voucher is communicated to the casino EGM management system (i.e., the gaming establishment device management system) to save such events in association with the EGM technician servicing the EGM. In this example, the system additionally updates (or operates with a gaming establishment ticket voucher system to update) the record for that ticket voucher to limit redemption of the ticket voucher to at a casino cage (which enables casino staff to properly investigate the person attempting to redeem the ticket voucher and perform any additional investigation warranted). Put differently, the system of this embodiment causes a modification of the state of the ticket voucher to prevent redemption of that ticket voucher at a kiosk or an EGM.

In certain embodiments, the association of a ticket voucher printed or issued by an EGM as a potentially illegal ticket voucher additionally or alternatively includes the system modifying (or operating with a gaming establishment ticket voucher system to modify) one or more parameters of the ticket voucher by preventing non-qualified staff at a casino cage (e.g., junior casino cage staff members) from being enabled to redeem the illegal ticket voucher. In these embodiments, the modification of the parameters of the ticket voucher result in requiring qualified staff at the casino cage (e.g., senior casino cage staff members) to approve any redemption of such a ticket voucher.

In certain embodiments, the association of a ticket voucher printed or issued by an EGM as a potentially illegal ticket voucher additionally or alternatively includes the system requiring gaming establishment staff to capture information associated with the person redeeming the ticket voucher to enable historic redemptions to be tracked. For example, a member of casino staff at a gaming establishment cage is required to obtain identification credentials (e.g., name, address, birthdate, physical characteristics, photo or scan of a government issued identification) of the person attempting to redeem a ticket voucher designated as a potentially illegal ticket voucher.

In certain embodiments, the system employs this information to perform a background check on the person to determine if they have a criminal record and display such information to gaming establishment personnel to help inform them if it is safe or advised to redeem the ticket voucher for the person. In certain embodiments, the system additionally or alternatively employs the scanned identification information to track or associate historic redemptions of ticket vouchers flagged as potentially illegal ticket vouchers to help identify if there is a long-term pattern of people attempting to redeem such flagged ticket vouchers.

In certain embodiments, the system additionally or alternatively employs the scanned identification information to track or associate historic redemptions attempted by a particular person. In one such embodiment, the system invokes a threshold (e.g., $1000 worth of ticket vouchers flagged as potentially illegal ticket vouchers to be redeemed over a month, and/or $5000 worth of ticket vouchers flagged as potentially illegal ticket vouchers to be redeemed per year) and if a particular person hits one or more threshold limits in attempted redemptions of ticket vouchers associated with a limited redemption, then non-qualified gaming establishment personnel (e.g., junior staff at a casino cage) cannot redeem any ticket vouchers for the requesting person (and only qualified gaming establishment personnel (e.g., senior staff at the casino cage) can redeem a ticket voucher from that person). In another such embodiment, if a particular person hits one or more threshold limits in attempted redemptions of ticket vouchers associated with a limited redemption, the system bans that person from making any further redemptions of ticket vouchers flagged as potentially illegal ticket vouchers. In another embodiment, the system additionally or alternatively publishes the particular person to one or more gaming establishment ban lists.

In certain embodiments in which the tracked event associated with gaming establishment personnel includes the deposit of funds by gaming establishment personnel in association with interfacing with an EGM, and then, with or without using such funds to wager on any plays of any games and potentially obtaining more funds via such plays being winning plays, an attempted transfer, by the gaming establishment personnel of part or all of such funds to a gaming establishment account, such as a cashless wagering account, associated with the gaming establishment personnel, the system prevents the transfer of these funds to the gaming establishment account. In certain embodiments in which the tracked event associated with gaming establishment personnel includes the deposit of funds by gaming establishment personnel in association with interfacing with an EGM followed by an attempted transfer, by an accomplice of the gaming establishment personnel (e.g., a user who logs into the EGM while funds are already on the credit meter of the EGM following the gaming establishment personnel servicing the EGM and who may or may not use such funds to wager on any plays of any games and potentially obtain more funds via such plays being winning plays), of part or all of such funds to a gaming establishment account associated with the compliance, the system prevents the transfer of these funds to the gaming establishment account. In these embodiments, the system limits the cashing out of such funds to a ticket voucher. Such limiting the funds to be cashed out to a ticket voucher enables the system to impose, as described above, one or more additional redemption restrictions based on the tracking of the funds that resulted in the attempted transfer by gaming establishment personnel and/or an identified accomplice and the subsequent issuance of a ticket voucher.

Accordingly, the system of the present disclosure tracks one or more events occurring based on gaming establishment personnel interacting with a gaming establishment device, such as an EGM or a ticket voucher kiosk. In these embodiments, while such tracked events may occur (and be expected to occur) during gaming establishment personnel interacting with one or more gaming establishment devices, in certain instances, these tracked events may be indicative of potential embezzlement activities by gaming establishment personnel. In addition to tracking one or more events that may be affiliated with certain malicious behavior by gaming establishment personnel, the system of the present disclosure undertakes one or more actions to counteract these potential attempts at embezzling funds. In such embodiments, responsive to one or more occurrences of such tracked events, the system takes zero, one or more prohibit measures that individually or collectively minimize (or eliminate) certain of the potential embezzlement activities of malicious gaming establishment personnel.

It should be appreciated that any functionality or process of the present disclosure may be implemented via one or more servers (associated with or independent of any component of any system of the present disclosure), one or more gaming establishment devices (e.g., a gaming device such as an EGM or a non-gaming device such as a kiosk or point-of-sale terminal), one or more components of a gaming establishment device (such as a component of a gaming establishment device management system supported by or otherwise located inside the gaming establishment device), one or more components of the gaming establishment device management system, one or more components of the ticket voucher system, or a mobile device application.

As indicated above, in various embodiments, one or more actions occur between a mobile device and one or more components of the ticket voucher system, the gaming establishment device management system and/or the gaming establishment device via one or more wireless communication protocols between the mobile device and the component of the ticket voucher system, the component of the gaming establishment device management system, and/or the gaming establishment device. In certain embodiments, the communication with the mobile device can occur through one or more wireless interfaces of the component of the ticket voucher system, the component of the gaming establishment device management system, and/or the gaming establishment device. In one embodiment, the wireless interface is integrated into the cabinet of the component of the ticket voucher system, the component of the gaming establishment device management system, and/or the gaming establishment device and a processor of the component of the ticket voucher system, the component of the gaming establishment device management system, and/or the gaming establishment device is configured to communicate directly with and send control commands to the wireless interface. In another embodiment, the wireless interface is integrated into a device mounted to and/or within the cabinet of the component of the ticket voucher system, the component of the gaming establishment device management system, and/or the gaming establishment device. In certain embodiments where the wireless interface is embedded in a secondary device, the processor of the component of the ticket voucher system, the component of the gaming establishment device management system, and/or the gaming establishment device sends control commands to control the wireless interface via a secondary controller.

In certain embodiments which utilize a near field communication (NFC) implementation, the mobile device application registers a mobile device application with one or more processors of the mobile device. In these embodiments, when the mobile device is detected by an NFC reader of a component of the component of the ticket voucher system, the component of the gaming establishment device management system, and/or the gaming establishment device, the component of the ticket voucher system, the component of the gaming establishment device management system, and/or the gaming establishment device, such a component/device communicates one or more data messages to the mobile device (or to one or more servers which then communicate such data messages to the mobile device). Such data messages are commands generated by the component of the ticket voucher system, the component of the gaming establishment device management system, and/or the gaming establishment device when the mobile device is detected in the NFC reader field. The processor of the mobile device communicates the data message to the mobile device application. The mobile device application responds, such as communicating a triggering message, and a communication channel is opened between the component of the ticket voucher system, the component of the gaming establishment device management system, and/or the gaming establishment device and the mobile device application (or between the component of the ticket voucher system, the component of the gaming establishment device management system, and/or the gaming establishment device, one or more servers and the mobile device application). This open communication channel enables the component of the ticket voucher system, the component of the gaming establishment device management system, and/or the gaming establishment device to send, though the NFC reader, additional data messages to the mobile device (or to the mobile device via one or more servers) which are responded to by the mobile device application of the mobile device. It should be appreciated that as long as the mobile device remains within the NFC field, the component of the ticket voucher system, the component of the gaming establishment device management system, and/or the gaming establishment device is configured to communicate with the mobile device and send data, such as status updates, as necessary. However, once the mobile device is removed from the NFC field, the communication channel is closed and such status updates must be discontinued.

In other embodiments, the wireless interface implements a Wi-Fi, cellular and/or Bluetooth™ communications protocol to facilitate the communication of data between the mobile device and the component of the ticket voucher system, the component of the gaming establishment device management system, and/or the gaming establishment device. In such embodiments, Bluetooth™ pairing occurs when two Bluetooth devices agree to communicate with each other and establish a connection. In order to pair two Bluetooth wireless devices, a password (passkey) is exchanged between the two devices. The Passkey is a code shared by both Bluetooth devices, which proves that both users have agreed to pair with each other. After the passkey code is exchanged, an encrypted communication can be set up between the pair devices. In Wi-Fi paring, every pairing can be set up with WPA2 encryption or another type of encryption scheme to keep the transfer private. Wi-Fi Direct is an example of a protocol that can be used to establish point-to-point communications between two Wi-Fi devices. The protocol enables for a Wi-Fi device pair directly with another without having to first join a local network.

It should be appreciated that Wi-Fi, cellular or Bluetooth™ communication protocols can be used in lieu of or in combination with NFC. For instance, an NFC communication can be used to instantiate a Wi-Fi or Bluetooth™ communication between the component of the ticket voucher system, the component of the gaming establishment device management system, and/or the gaming establishment device, zero, one or more servers and a mobile device, such as secure pairing using one of these protocols. That is, in one embodiment, an NFC interface on a component of the component of the ticket voucher system, the component of the gaming establishment device management system, and/or the gaming establishment device and/or the gaming establishment device can be used to set-up a higher speed communication between the component of the ticket voucher system, the component of the gaming establishment device management system, and/or the gaming establishment device, zero, one or more servers and the NFC enabled mobile device. The higher speed communication rates can be used for expanded content sharing. For instance, a NFC and Bluetooth enabled component of the component of the ticket voucher system, the component of the gaming establishment device management system, and/or the gaming establishment device can be tapped by an NFC and Bluetooth enabled mobile device for instant Bluetooth pairing between the devices and zero, one or more servers. Instant Bluetooth pairing between a component of the component of the ticket voucher system, the component of the gaming establishment device management system, and/or the gaming establishment device, an NFC enabled mobile device and zero, one or more servers, can save searching, waiting, and entering codes. In another example, a component of the component of the ticket voucher system, the component of the gaming establishment device management system, and/or the gaming establishment device can be configured as an NFC enabled router, such as a router supporting a Wi-Fi communication standard. Tapping an NFC enabled mobile device to an NFC enabled and Wi-Fi enabled component of the component of the ticket voucher system, the component of the gaming establishment device management system, and/or the gaming establishment device can be used to establish a Wi-Fi connection between the components/devices and zero, one or more servers.

In certain embodiments which implement a Wi-Fi, cellular and/or Bluetooth™ communications protocol, the system utilizes one or more QR codes generated by the component of the ticket voucher system, the component of the gaming establishment device management system, and/or the gaming establishment device to facilitate the communication of data between the mobile device and the system. In such embodiments, the QR code is used to identify the component of the ticket voucher system, the component of the gaming establishment device management system, and/or the gaming establishment device that is displaying the QR code to identify the server to which the mobile device should connect. It should be appreciated that the QR code enables the system to establish a secure tunnel or path from the mobile device to the gaming establishment's Wi-Fi network and then to the gaming establishment's wired network and finally to the component of the ticket voucher system, the component of the gaming establishment device management system, and/or the gaming establishment device. In these embodiments, a communication tunnel wrapper (i.e., a Wi-Fi/Bluetooth™ tunnel wrapper) is utilized to establish a connection between the system and the mobile device and to transport any data messages described herein between the component of the ticket voucher system, the component of the gaming establishment device management system, and/or the gaming establishment device, zero, one or more servers and the mobile device.

More specifically, in certain embodiments, the user requests, via an input at the component of the ticket voucher system, the component of the gaming establishment device management system, and/or the gaming establishment device and/or the mobile device, the generation of a QR code by the component of the ticket voucher system, the component of the gaming establishment device management system, and/or the gaming establishment device. In response to the user's request, the component of the ticket voucher system, the component of the gaming establishment device management system, and/or the gaming establishment device displays a QR code. In certain embodiments, the QR code includes a nonce which prevents a third-party (e.g., another user) from sniping the user's login attempt. Such an on-demand QR code remains valid for a designated amount of time such that if the user does not scan the QR code within the designated amount of time, another QR code is necessary to be scanned to connect the mobile device to the component of the ticket voucher system, the component of the gaming establishment device management system, and/or the gaming establishment device.

In these embodiments, the user scans the QR code with the mobile device application. If the system determines that the QR code is valid (i.e., not expired), the mobile device application will connect to the system. It should be appreciated that as long as the established connection between the mobile device and the system remains active, one or more system servers and mobile device may communicate data, such as status updates, as necessary. It should be further appreciated that in association with the Wi-Fi or Bluetooth™ or mobile device network communications protocol described herein, any action requested by the user via the mobile device application does not require a new engagement between the mobile device and the component of the ticket voucher system, the component of the gaming establishment device management system, and/or the gaming establishment device, such as a new scanning of the QR code to send such a requested action from the mobile device to the component of the ticket voucher system, the component of the gaming establishment device management system, and/or the gaming establishment device (or to send a requested action from the mobile device to one or more servers and then from one or more servers to the component of the ticket voucher system, the component of the gaming establishment device management system, and/or the gaming establishment device).

In certain embodiments, following the scanning of a valid QR code, the mobile device application connects to one or more servers. In certain embodiments, after establishing a connection with one or more servers, the mobile device application transmits a connect command to the system. In response to receiving a connect command from the mobile device, the system sends a message to the mobile device. This message serves to encapsulate various commands between the system and the mobile device. In these embodiments, if the mobile device application does not receive this message within a designated period of time, such as within five seconds, the mobile device application displays an error message to the user and directs the user to rescan the QR code.

In addition to the connect command communicated from the mobile device application to the system, the mobile device application of these embodiments is configured to send a disconnect command to the system. Such a disconnect command functions to tear-down the connection the server. It should be appreciated that if the mobile device connection is severed before this command is received by the system, the sever sends this command on behalf of the mobile device application;

In another embodiment, the mobile device application is configured to send a trigger command to the system, such as a component of the component of the ticket voucher system, the component of the gaming establishment device management system, and/or the gaming establishment device. In this embodiment, the trigger command is associated with an action requested by the user. In such embodiments, when the system receives the trigger command from the mobile device application, the system will communicate the appropriate requests to the mobile device application. If the mobile device application does not receive these requests within a designated amount of time, such as five seconds, the mobile device application will display an error message to the user and enable the user to retry the requested action.

In other embodiments, the mobile device application communicates with the system through a tunnel established over the mobile device's Wi-FI network or the mobile device's network connection. In such embodiments, the mobile device application will connect to one or more system servers which use websockets secured with a transport layer security protocol. The system server operates with one or more translators, similarly using websockets secured with a transport layer security protocol to communicate data to the component of the ticket voucher system, the component of the gaming establishment device management system, and/or the gaming establishment device.

In certain embodiments which utilize the NFC communication protocol described herein, which utilize the Wi-Fi, cellular and/or Bluetooth™ communication protocols described herein and/or which utilize any other communication protocol described herein, any action requested by the user via the mobile device application requires a new engagement between the mobile device and the component of the ticket voucher system, the component of the gaming establishment device management system, and/or the gaming establishment device, such as a new tap of the mobile device to a card reader or other designated location(s) of the component of the ticket voucher system, the component of the gaming establishment device management system, and/or the gaming establishment device. In certain other embodiments which utilize the NFC communication protocol described herein, which utilize the Wi-Fi, cellular and/or Bluetooth™ communication protocols described herein and/or which utilize any other communication protocol described herein, certain actions requested by the user via the mobile device application requires a new engagement between the mobile device and the component of the ticket voucher system, the component of the gaming establishment device management system, and/or the gaming establishment device, such as a new tap of the mobile device to a card reader or other designated location(s) of the component of the ticket voucher system, the component of the gaming establishment device management system, and/or the gaming establishment device and other actions requested by the user via the mobile device application do not require any new engagement between the mobile device and the component of the ticket voucher system, the component of the gaming establishment device management system, and/or the gaming establishment device.

It should be appreciated that while certain data or information pertaining to one or more of the requested actions are communicated between the component of the ticket voucher system, the component of the gaming establishment device management system, and/or the gaming establishment device and a mobile device, such data or information may additionally or alternatively be communicated: (i) between one or more servers and a mobile device via one or more wireless communication protocols, or (ii) between a component of the component of the ticket voucher system, the component of the gaming establishment device management system, and/or the gaming establishment device and one or more servers via one or more wireless communication protocols and then from one or more servers to a mobile device via one or more wireless communication protocols.

In certain embodiments, the above-described embodiments of the present disclosure may be implemented in accordance with or in conjunction with: (i) zero, one or more components of a ticket voucher system, (ii) zero, one or more components of a gaming establishment device management system, and/or (iii) zero, one or more gaming establishment devices (e.g., a gaming device such as an EGM or a non-gaming device such as a kiosk or point-of-sale terminal). In these embodiments, such components of the fund management system and/or the gaming establishment device each include a controller including at least one processor.

The at least one processor is any suitable processing device or set of processing devices, such as a microprocessor, a microcontroller-based platform, a suitable integrated circuit, or one or more application-specific integrated circuits (ASICs), configured to execute software enabling various configuration and reconfiguration tasks, such as: (1) communicating with a remote source (such as a server that stores authentication information or fund information) via a communication interface of the controller; (2) converting signals read by an interface to a format corresponding to that used by software or memory of the component of the ticket voucher system, the component of the gaming establishment device management system, and/or the gaming establishment device; (3) accessing memory to configure or reconfigure parameters in the memory according to indicia read from the component of the ticket voucher system, the component of the gaming establishment device management system, and/or the gaming establishment device; (4) communicating with interfaces and the peripheral devices (such as input/output devices); and/or (5) controlling the peripheral devices. In certain embodiments, one or more components of the controller (such as the at least one processor) reside within a housing of the component of the ticket voucher system, the component of the gaming establishment device management system, and/or the gaming establishment device, while in other embodiments, at least one component of the controller resides outside of the housing of the component of the ticket voucher system, the component of the gaming establishment device management system, and/or the gaming establishment device.

The controller also includes at least one memory device, which includes: (1) volatile memory (e.g., RAM which can include non-volatile RAM, magnetic RAM, ferroelectric RAM, and any other suitable forms); (2) non-volatile memory (e.g., disk memory, FLASH memory, EPROMs, EEPROMs, memristor-based non-volatile solid-state memory, etc.); (3) unalterable memory (e.g., EPROMs); (4) read-only memory; and/or (5) a secondary memory storage device, such as a non-volatile memory device, configured to store software related information (the software related information and the memory may be used to store various files not currently being used and invoked in a configuration or reconfiguration). Any other suitable magnetic, optical, and/or semiconductor memory may operate in conjunction with the component of the ticket voucher system, the component of the gaming establishment device management system, and/or the gaming establishment device disclosed herein. In certain embodiments, the at least one memory device resides within the housing of the component of the ticket voucher system, the component of the gaming establishment device management system, and/or the gaming establishment device, while in other embodiments at least one component of the at least one memory device resides outside of the housing of the component of the ticket voucher system, the component of the gaming establishment device management system, and/or the gaming establishment device. In these embodiments, any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

The at least one memory device is configured to store, for example: (1) configuration software, such as all the parameters and settings on the component of the ticket voucher system, the component of the gaming establishment device management system, and/or the gaming establishment device; (2) associations between configuration indicia read from a component of the fund management system with one or more parameters and settings; (3) communication protocols configured to enable the at least one processor to communicate with the peripheral devices; and/or (4) communication transport protocols (such as TCP/IP, USB, Firewire, IEEE1394, Bluetooth, IEEE 802.11x (IEEE 802.11 standards), hiperlan/2, HomeRF, etc.) configured to enable the component of the ticket voucher system, the component of the gaming establishment device management system, and/or the gaming establishment device to communicate with local and non-local devices using such protocols. In one implementation, the controller communicates with other devices using a serial communication protocol. A few non-limiting examples of serial communication protocols that other devices, such as peripherals (e.g., a bill validator or a ticket printer), may use to communicate with the controller include USB, RS-232, and Netplex (a proprietary protocol developed by IGT).

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the player's computer, partly on the player's computer, as a stand-alone software package, partly on the player's computer and partly on a remote computer or entirely on the remote computer or server. In the latter scenario, the remote computer may be connected to the player's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

In certain embodiments, the at least one memory device is configured to store program code and instructions executable by the at least one processor of the component of the ticket voucher system, the component of the gaming establishment device management system, and/or the gaming establishment device to control the component of the ticket voucher system, the component of the gaming establishment device management system, and/or the gaming establishment device. In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium. In certain such embodiments, an operator (such as a gaming establishment operator) and/or a user uses such a removable memory device in a component of the fund management system to implement at least part of the present disclosure. In other embodiments, part or all of the program code and/or the operating data is downloaded to the at least one memory device of the component of the ticket voucher system, the component of the gaming establishment device management system, and/or the gaming establishment device through any suitable data network described above (such as an Internet or intranet).

The at least one memory device also stores a plurality of device drivers. Examples of different types of device drivers include device drivers for the component of the ticket voucher system, the component of the gaming establishment device management system, and/or the gaming establishment device and device drivers for the peripheral components. Typically, the device drivers utilize various communication protocols that enable communication with a particular physical device. The device driver abstracts the hardware implementation of that device. For example, a device driver may be written for each type of card reader that could potentially be connected to the component of the ticket voucher system, the component of the gaming establishment device management system, and/or the gaming establishment device. Non-limiting examples of communication protocols used to implement the device drivers include Netplex, USB, Serial, Ethernet, Firewire, I/O debouncer, direct memory map, serial, PCI, parallel, RF, Bluetooth™, near-field communications (e.g., using near-field magnetics), 802.11 (WiFi), etc. In one embodiment, when one type of a particular device is exchanged for another type of the particular device, the at least one processor of the component of the ticket voucher system, the component of the gaming establishment device management system, and/or the gaming establishment device loads the new device driver from the at least one memory device to enable communication with the new device. For instance, one type of card reader in the component of the ticket voucher system, the component of the gaming establishment device management system, and/or the gaming establishment device can be replaced with a second different type of card reader when device drivers for both card readers are stored in the at least one memory device.

In certain embodiments, the software units stored in the at least one memory device can be upgraded as needed. For instance, when the at least one memory device is a hard drive, new parameters, new settings for existing parameters, new settings for new parameters, new device drivers, and new communication protocols can be uploaded to the at least one memory device from the controller or from some other external device. As another example, when the at least one memory device includes a CD/DVD drive including a CD/DVD configured to store options, parameters, and settings, the software stored in the at least one memory device can be upgraded by replacing a first CD/DVD with a second CD/DVD. In yet another example, when the at least one memory device uses flash memory or EPROM units configured to store options, parameters, and settings, the software stored in the flash and/or EPROM memory units can be upgraded by replacing one or more memory units with new memory units that include the upgraded software. In another embodiment, one or more of the memory devices, such as the hard drive, may be employed in a software download process from a remote software server.

In some embodiments, the at least one memory device also stores authentication and/or validation components configured to authenticate/validate specified components of the component of the ticket voucher system, the component of the gaming establishment device management system, and/or the gaming establishment device and/or information, such as hardware components, software components, firmware components, peripheral device components, user input device components, information received from one or more user input devices, information stored in the at least one memory device, etc.

In certain embodiments, the peripheral devices include several device interfaces, such as, but not limited to: (1) at least one output device including at least one display device; (2) at least one input device (which may include contact and/or non-contact interfaces); (3) at least one transponder; (4) at least one wireless communication component; (5) at least one wired/wireless power distribution component; (6) at least one sensor; (7) at least one data preservation component; (8) at least one motion/gesture analysis and interpretation component; (9) at least one motion detection component; (10) at least one portable power source; (11) at least one geolocation module; (12) at least one user identification module; (13) at least one user/device tracking module; and (14) at least one information filtering module.

The at least one output device includes at least one display device configured to display any suitable information. In certain embodiments, the display devices are connected to or mounted on a housing of the component of the ticket voucher system, the component of the gaming establishment device management system, and/or the gaming establishment device. In various embodiments, the display devices serve as digital glass configured to aspects of the gaming establishment in which the component of the ticket voucher system, the component of the gaming establishment device management system, and/or the gaming establishment device is located. In various embodiments, the component of the ticket voucher system, the component of the gaming establishment device management system, and/or the gaming establishment device includes zero, one or more of the following display devices: (a) a central display device; (b) a player tracking display configured to display various information regarding a user's player tracking status; (c) a secondary or upper display device in addition to the central display device and the player tracking display; (d) a credit display configured to display a current quantity of credits, amount of cash, account balance, or the equivalent; and (e) a bet display. In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device includes a touch-screen with an associated touch-screen controller. The display devices may be of any suitable sizes, shapes, and configurations.

In various embodiments, the at least one output device includes a payout device. In these embodiments, after the component of the ticket voucher system, the component of the gaming establishment device management system, and/or the gaming establishment device receives an actuation, the component of the ticket voucher system, the component of the gaming establishment device management system, and/or the gaming establishment device causes the payout device to provide a payment to the player. In one embodiment, the payout device is one or more of: (a) a ticket printer and dispenser configured to print and dispense a ticket or credit slip associated with a monetary value, wherein the ticket or credit slip may be redeemed for its monetary value via a cashier, a kiosk, or other suitable redemption system; (b) a bill dispenser configured to dispense paper currency; (c) a coin dispenser configured to dispense coins or tokens (such as into a coin payout tray); and (d) any suitable combination thereof. In certain embodiments, rather than dispensing bills, coins, or a physical ticket having a monetary value to the player following receipt of an actuation of the cashout device, the payout device is configured to cause a payment to be provided to the player in the form of an electronic funds transfer, such as via a direct deposit into a bank account, a casino account, or a prepaid account of the player; via a transfer of funds onto an electronically recordable identification card or smart card of the player; or via sending a virtual ticket having a monetary value to an electronic device of the player.

In certain embodiments, the at least one output device is a sound generating device controlled by one or more sound cards. In one such embodiment, the sound generating device includes one or more speakers or other sound generating hardware and/or software configured to generate sounds, such as by playing music. In another such embodiment, the component of the ticket voucher system, the component of the gaming establishment device management system, and/or the gaming establishment device provides dynamic sounds coupled with attractive multimedia images displayed on one or more of the display devices to provide an audio-visual representation or to otherwise display full-motion video with sound to attract players to the component of the ticket voucher system, the component of the gaming establishment device management system, and/or the gaming establishment device. In certain embodiments, the component of the ticket voucher system, the component of the gaming establishment device management system, and/or the gaming establishment device displays a sequence of audio and/or visual attraction messages during idle periods to attract potential players to the component of the ticket voucher system, the component of the gaming establishment device management system, and/or the gaming establishment device. The videos may be customized to provide any appropriate information.

The at least one input device may include any suitable device that enables an input signal to be produced and received by the at least one processor of the component of the ticket voucher system, the component of the gaming establishment device management system, and/or the gaming establishment device. In one embodiment, the at least one input device includes a payment device configured to communicate with the at least one processor of the component of the ticket voucher system, the component of the gaming establishment device management system, and/or the gaming establishment device to fund the component of the ticket voucher system, the component of the gaming establishment device management system, and/or the gaming establishment device. In certain embodiments, the payment device includes zero, one or more of: (a) a bill acceptor into which paper money is inserted; (b) a ticket acceptor into which a ticket or a voucher is inserted; (c) a reader or a validator for credit cards, debit cards, or credit slips into which a credit card, debit card, or credit slip is inserted; (d) a player identification card reader into which a player identification card is inserted; or (e) any suitable combination thereof. In one embodiment, the at least one input device includes a payment device configured to enable the component of the ticket voucher system, the component of the gaming establishment device management system, and/or the gaming establishment device to be funded via an electronic funds transfer, such as a transfer of funds from a bank account. In another embodiment, the component of the ticket voucher system, the component of the gaming establishment device management system, and/or the gaming establishment device includes a payment device configured to communicate with a mobile device of a player, such as a mobile phone, a radio frequency identification tag, or any other suitable wired or wireless device, to retrieve relevant information associated with that player to fund the component of the ticket voucher system, the component of the gaming establishment device management system, and/or the gaming establishment device. When the component of the ticket voucher system, the component of the gaming establishment device management system, and/or the gaming establishment device is funded, the at least one processor determines the amount of funds entered and displays the corresponding amount.

In various embodiments, the at least one input device includes a plurality of buttons that are programmable by the component of the ticket voucher system, the component of the gaming establishment device management system, and/or the gaming establishment device operator to, when actuated, cause the component of the ticket voucher system, the component of the gaming establishment device management system, and/or the gaming establishment device to perform particular functions. For instance, such buttons may be hard keys, programmable soft keys, or icons icon displayed on a display device of the component of the ticket voucher system, the component of the gaming establishment device management system, and/or the gaming establishment device that are actuatable via a touch screen of the component of the ticket voucher system, the component of the gaming establishment device management system, and/or the gaming establishment device or via use of a suitable input device of the component of the ticket voucher system, the component of the gaming establishment device management system, and/or the gaming establishment device. In certain embodiments, the at least one input device includes a touch-screen coupled to a touch-screen controller or other touch-sensitive display overlay to enable interaction with any images displayed on a display device (as described below). One such input device is a conventional touch-screen button panel. The touch-screen and the touch-screen controller are connected to a video controller. In these embodiments, signals are input to the component of the ticket voucher system, the component of the gaming establishment device management system, and/or the gaming establishment device by touching the touch screen at the appropriate locations.

The at least one wireless communication component includes one or more communication interfaces having different architectures and utilizing a variety of protocols, such as (but not limited to) 802.11 (WiFi); 802.15 (including Bluetooth™); 802.16 (WiMax); 802.22; cellular standards such as CDMA, CDMA2000, and WCDMA; Radio Frequency (e.g., RFID); infrared; and Near Field Magnetic communication protocols. The at least one wireless communication component transmits electrical, electromagnetic, or optical signals that carry digital data streams or analog signals representing various types of information.

The at least one wired/wireless power distribution component includes components or devices that are configured to provide power to other devices. For example, in one embodiment, the at least one power distribution component includes a magnetic induction system that is configured to provide wireless power to one or more user input devices near the component of the ticket voucher system, the component of the gaming establishment device management system, and/or the gaming establishment device. In one embodiment, a user input device docking region is provided, and includes a power distribution component that is configured to recharge a user input device without requiring metal-to-metal contact. In one embodiment, the at least one power distribution component is configured to distribute power to one or more internal components of the component of the ticket voucher system, the component of the gaming establishment device management system, and/or the gaming establishment device, such as one or more rechargeable power sources (e.g., rechargeable batteries) located at the component of the ticket voucher system, the component of the gaming establishment device management system, and/or the gaming establishment device.

In certain embodiments, the at least one sensor includes at least one of: optical sensors, pressure sensors, RF sensors, infrared sensors, image sensors, thermal sensors, and biometric sensors. The at least one sensor may be used for a variety of functions, such as: detecting movements and/or gestures of various objects within a predetermined proximity to the component of the ticket voucher system, the component of the gaming establishment device management system, and/or the gaming establishment device; detecting the presence and/or identity of various persons (e.g., players, casino employees, etc.), devices (e.g., user input devices), and/or systems within a predetermined proximity to the component of the ticket voucher system, the component of the gaming establishment device management system, and/or the gaming establishment device.

The at least one data preservation component is configured to detect or sense one or more events and/or conditions that, for example, may result in damage to the component of the ticket voucher system, the component of the gaming establishment device management system, and/or the gaming establishment device and/or that may result in loss of information associated with the component of the ticket voucher system, the component of the gaming establishment device management system, and/or the gaming establishment device. Additionally, the data preservation system may be operable to initiate one or more appropriate action(s) in response to the detection of such events/conditions.

The at least one motion/gesture analysis and interpretation component is configured to analyze and/or interpret information relating to detected player movements and/or gestures to determine appropriate player input information relating to the detected player movements and/or gestures. For example, in one embodiment, the at least one motion/gesture analysis and interpretation component is configured to perform one or more of the following functions: analyze the detected gross motion or gestures of a player; interpret the player's motion or gestures (e.g., in the context of a casino game being played) to identify instructions or input from the player; utilize the interpreted instructions/input to advance the game state; etc. In other embodiments, at least a portion of these additional functions may be implemented at a remote system or device.

The at least one portable power source enables the component of the ticket voucher system, the component of the gaming establishment device management system, and/or the gaming establishment device to operate in a mobile environment.

The at least one geolocation module is configured to acquire geolocation information from one or more remote sources and use the acquired geolocation information to determine information relating to a relative and/or absolute position of the component of the ticket voucher system, the component of the gaming establishment device management system, and/or the gaming establishment device. For example, in one implementation, the at least one geolocation module is configured to receive GPS signal information for use in determining the position or location of the component of the ticket voucher system, the component of the gaming establishment device management system, and/or the gaming establishment device. In another implementation, the at least one geolocation module is configured to receive multiple wireless signals from multiple remote devices (e.g., the component of the ticket voucher system, the component of the gaming establishment device management system, and/or the gaming establishment device, servers, wireless access points, etc.) and use the signal information to compute position/location information relating to the position or location of the component of the ticket voucher system, the component of the gaming establishment device management system, and/or the gaming establishment device.

The at least one user identification module is configured to determine the identity of the current user or current owner of the component of the ticket voucher system, the component of the gaming establishment device management system, and/or the gaming establishment device. For example, in one embodiment, the current user is required to perform a login process at the component of the ticket voucher system, the component of the gaming establishment device management system, and/or the gaming establishment device in order to access one or more features. Alternatively, the component of the ticket voucher system, the component of the gaming establishment device management system, and/or the gaming establishment device is configured to automatically determine the identity of the current user based on one or more external signals, such as an RFID tag or badge worn by the current user and that provides a wireless signal to the component of the ticket voucher system, the component of the gaming establishment device management system, and/or the gaming establishment device that is used to determine the identity of the current user. In at least one embodiment, various security features are incorporated into the component of the ticket voucher system, the component of the gaming establishment device management system, and/or the gaming establishment device to prevent unauthorized users from accessing confidential or sensitive information.

The at least one information filtering module is configured to perform filtering (e.g., based on specified criteria) of selected information to be displayed at one or more displays of the component of the ticket voucher system, the component of the gaming establishment device management system, and/or the gaming establishment device.

In various embodiments, the component of the ticket voucher system, the component of the gaming establishment device management system, and/or the gaming establishment device includes a plurality of communication ports configured to enable the at least one processor of the component of the ticket voucher system, the component of the gaming establishment device management system, and/or the gaming establishment device to communicate with and to operate with external peripherals, such as: accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumbsticks, ticket readers, touch screens, trackballs, touchpads, wheels, and wireless communication devices.

As generally described above, in certain embodiments, the component of the ticket voucher system, the component of the gaming establishment device management system, and/or the gaming establishment device has a support structure, housing, or cabinet that provides support for a plurality of the input devices and the output devices of the component of the ticket voucher system, the component of the gaming establishment device management system, and/or the gaming establishment device.

It should be appreciated that certain of the gaming establishment devices of the present disclosure, such as EGMs located in a casino or another gaming establishment, include certain components and/or are configured to operate in certain manners that differentiate these gaming establishment devices from general purpose computing devices, such as certain personal gaming devices (e.g., desktop computers and laptop computers).

For instance, EGMs are highly regulated to ensure fairness and, in many cases, EGMs are configured to award monetary awards up to multiple millions of dollars. To satisfy security and regulatory requirements in a gaming environment, hardware and/or software architectures are implemented in EGMs that differ significantly from those of general purpose computing devices. For purposes of illustration, a description of EGMs relative to general purpose computing devices and some examples of these additional (or different) hardware and/or software architectures found in EGMs are described below.

At first glance, one might think that adapting general purpose computing device technologies to the gaming industry and EGMs would be a simple proposition because both general purpose computing devices and EGMs employ processors that control a variety of devices. However, due to at least: (1) the regulatory requirements placed on EGMs, (2) the harsh environment in which EGMs operate, (3) security requirements, and (4) fault tolerance requirements, adapting general purpose computing device technologies to EGMs can be quite difficult. Further, techniques and methods for solving a problem in the general purpose computing device industry, such as device compatibility and connectivity issues, might not be adequate in the gaming industry. For instance, a fault or a weakness tolerated in a general purpose computing device, such as security holes in software or frequent crashes, is not tolerated in an EGM because in an EGM these faults can lead to a direct loss of funds from the EGM, such as stolen cash or loss of revenue when the EGM is not operating properly or when the random outcome determination is manipulated.

Certain differences between general purpose computing devices and EGMs are described below. A first difference between EGMs and general purpose computing devices is that EGMs are state-based systems. A state-based system stores and maintains its current state in a non-volatile memory such that, in the event of a power failure or other malfunction, the state-based system can return to that state when the power is restored or the malfunction is remedied. For instance, for a state-based EGM, if the EGM displays an award for a game of chance but the power to the EGM fails before the EGM provides the award to the player, the EGM stores the pre-power failure state in a non-volatile memory, returns to that state upon restoration of power, and provides the award to the player. This requirement affects the software and hardware design on EGMs. General purpose computing devices are not state-based machines, and a majority of data is usually lost when a malfunction occurs on a general purpose computing device.

A second difference between EGMs and general purpose computing devices is that, for regulatory purposes, the software on the EGM utilized to operate the EGM has been designed to be static and monolithic to prevent cheating by the operator of the EGM. For instance, one solution that has been employed in the gaming industry to prevent cheating and to satisfy regulatory requirements has been to manufacture an EGM that can use a proprietary processor running instructions to provide the game of chance from an EPROM or other form of non-volatile memory. The coding instructions on the EPROM are static (non-changeable) and must be approved by a gaming regulators in a particular jurisdiction and installed in the presence of a person representing the gaming jurisdiction. Any changes to any part of the software required to generate the game of chance, such as adding a new device driver used to operate a device during generation of the game of chance, can require burning a new EPROM approved by the gaming jurisdiction and reinstalling the new EPROM on the EGM in the presence of a gaming regulator. Regardless of whether the EPROM solution is used, to gain approval in most gaming jurisdictions, an EGM must demonstrate sufficient safeguards that prevent an operator or a player of an EGM from manipulating the EGM's hardware and software in a manner that gives him an unfair, and in some cases illegal, advantage.

A third difference between EGMs and general purpose computing devices is authentication-EGMs storing code are configured to authenticate the code to determine if the code is unaltered before executing the code. If the code has been altered, the EGM prevents the code from being executed. The code authentication requirements in the gaming industry affect both hardware and software designs on EGMs. Certain EGMs use hash functions to authenticate code. For instance, one EGM stores game program code, a hash function, and an authentication hash (which may be encrypted). Before executing the game program code, the EGM hashes the game program code using the hash function to obtain a result hash and compares the result hash to the authentication hash. If the result hash matches the authentication hash, the EGM determines that the game program code is valid and executes the game program code. If the result hash does not match the authentication hash, the EGM determines that the game program code has been altered (i.e., may have been tampered with) and prevents execution of the game program code.

A fourth difference between EGMs and general purpose computing devices is that EGMs have unique peripheral device requirements that differ from those of a general purpose computing device, such as peripheral device security requirements not usually addressed by general purpose computing devices. For instance, monetary devices, such as coin dispensers, bill validators, and ticket printers and computing devices that are used to govern the input and output of cash or other items having monetary value (such as tickets) to and from an EGM have security requirements that are not typically addressed in general purpose computing devices. Therefore, many general purpose computing device techniques and methods developed to facilitate device connectivity and device compatibility do not address the emphasis placed on security in the gaming industry.

To address some of the issues described above, a number of hardware/software components and architectures are utilized in EGMs that are not typically found in general purpose computing devices. These hardware/software components and architectures, as described below in more detail, include but are not limited to watchdog timers, voltage monitoring systems, state-based software architecture and supporting hardware, specialized communication interfaces, security monitoring, and trusted memory.

Certain EGMs use a watchdog timer to provide a software failure detection mechanism. In a normally-operating EGM, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits include a loadable timeout counter register to enable the operating software to set the timeout interval within a certain range of time. A differentiating feature of some circuits is that the operating software cannot completely disable the function of the watchdog timer. In other words, the watchdog timer always functions from the time power is applied to the board.

Certain EGMs use several power supply voltages to operate portions of the computer circuitry. These can be generated in a central power supply or locally on the computer board. If any of these voltages falls out of the tolerance limits of the circuitry they power, unpredictable operation of the EGM may result. Though most modern general purpose computing devices include voltage monitoring circuitry, these types of circuits only report voltage status to the operating software. Out of tolerance voltages can cause software malfunction, creating a potential uncontrolled condition in the general purpose computing device. Certain EGMs have power supplies with relatively tighter voltage margins than that required by the operating circuitry. In addition, the voltage monitoring circuitry implemented in certain EGMs typically has two thresholds of control. The first threshold generates a software event that can be detected by the operating software and an error condition then generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the EGM.

As described above, certain EGMs are state-based machines. Different functions of the game provided by the EGM (e.g., bet, play, result, points in the graphical presentation, etc.) may be defined as a state. When the EGM moves a game from one state to another, the EGM stores critical data regarding the game software in a custom non-volatile memory subsystem. This ensures that the player's wager and credits are preserved and to minimize potential disputes in the event of a malfunction on the EGM. In general, the EGM does not advance from a first state to a second state until critical information that enables the first state to be reconstructed has been stored. This feature enables the EGM to recover operation to the current state of play in the event of a malfunction, loss of power, etc. that occurred just before the malfunction. In at least one embodiment, the EGM is configured to store such critical information using atomic transactions.

Generally, an atomic operation in computer science refers to a set of operations that can be combined so that they appear to the rest of the system to be a single operation with only two possible outcomes: success or failure. As related to data storage, an atomic transaction may be characterized as series of database operations which either all occur, or all do not occur. A guarantee of atomicity prevents updates to the database occurring only partially, which can result in data corruption.

To ensure the success of atomic transactions relating to critical information to be stored in the EGM memory before a failure event (e.g., malfunction, loss of power, etc.), memory that includes one or more of the following criteria be used: direct memory access capability; data read/write capability which meets or exceeds minimum read/write access characteristics (such as at least 5.08 Mbytes/sec (Read) and/or at least 38.0 Mbytes/sec (Write)). Memory devices that meet or exceed the above criteria may be referred to as “fault-tolerant” memory devices.

Typically, battery-backed RAM devices may be configured to function as fault-tolerant devices according to the above criteria, whereas flash RAM and/or disk drive memory are typically not configurable to function as fault-tolerant devices according to the above criteria. Accordingly, battery-backed RAM devices are typically used to preserve EGM critical data, although other types of non-volatile memory devices may be employed. These memory devices are typically not used in typical general purpose computing devices.

Thus, in at least one embodiment, the EGM is configured to store critical information in fault-tolerant memory (e.g., battery-backed RAM devices) using atomic transactions. Further, in at least one embodiment, the fault-tolerant memory is able to successfully complete all desired atomic transactions (e.g., relating to the storage of EGM critical information) within a time period of 200 milliseconds or less. In at least one embodiment, the time period of 200 milliseconds represents a maximum amount of time for which sufficient power may be available to the various EGM components after a power outage event has occurred at the EGM.

As described previously, the EGM may not advance from a first state to a second state until critical information that enables the first state to be reconstructed has been atomically stored. After the state of the EGM is restored during the play of a game of chance, game play may resume and the game may be completed in a manner that is no different than if the malfunction had not occurred. Thus, for example, when a malfunction occurs during a game of chance, the EGM may be restored to a state in the game of chance just before when the malfunction occurred. The restored state may include metering information and graphical information that was displayed on the EGM in the state before the malfunction. For example, when the malfunction occurs during the play of a card game after the cards have been dealt, the EGM may be restored with the cards that were previously displayed as part of the card game. As another example, a bonus game may be triggered during the play of a game of chance in which a player is required to make a number of selections on a video display screen. When a malfunction has occurred after the player has made one or more selections, the EGM may be restored to a state that shows the graphical presentation just before the malfunction including an indication of selections that have already been made by the player. In general, the EGM may be restored to any state in a plurality of states that occur in the game of chance that occurs while the game of chance is played or to states that occur between the play of a game of chance.

Game history information regarding previous games played such as an amount wagered, the outcome of the game, and the like may also be stored in a non-volatile memory device. The information stored in the non-volatile memory may be detailed enough to reconstruct a portion of the graphical presentation that was previously presented on the EGM and the state of the EGM (e.g., credits) at the time the game of chance was played. The game history information may be utilized in the event of a dispute. For example, a player may decide that in a previous game of chance that they did not receive credit for an award that they believed they won. The game history information may be used to reconstruct the state of the EGM before, during, and/or after the disputed game to demonstrate whether the player was correct or not in the player's assertion.

Another feature of EGMs is that they often include unique interfaces, including serial interfaces, to connect to specific subsystems internal and external to the EGM. The serial devices may have electrical interface requirements that differ from the “standard” EIA serial interfaces provided by general purpose computing devices. These interfaces may include, for example, Fiber Optic Serial, optically coupled serial interfaces, current loop style serial interfaces, etc. In addition, to conserve serial interfaces internally in the EGM, serial devices may be connected in a shared, daisy-chain fashion in which multiple peripheral devices are connected to a single serial channel.

The serial interfaces may be used to transmit information using communication protocols that are unique to the gaming industry. For example, IGT's Netplex is a proprietary communication protocol used for serial communication between EGMs. As another example, SAS is a communication protocol used to transmit information, such as metering information, from an EGM to a remote device. Often SAS is used in conjunction with a player tracking system.

Certain EGMs may alternatively be treated as peripheral devices to a casino communication controller and connected in a shared daisy chain fashion to a single serial interface. In both cases, the peripheral devices are assigned device addresses. If so, the serial controller circuitry must implement a method to generate or detect unique device addresses. General purpose computing device serial ports are not able to do this.

Security monitoring circuits detect intrusion into an EGM by monitoring security switches attached to access doors in the EGM cabinet. Access violations result in suspension of game play and can trigger additional security operations to preserve the current state of game play. These circuits also function when power is off by use of a battery backup. In power-off operation, these circuits continue to monitor the access doors of the EGM. When power is restored, the EGM can determine whether any security violations occurred while power was off, e.g., via software for reading status registers. This can trigger event log entries and further data authentication operations by the EGM software.

Trusted memory devices and/or trusted memory sources are included in an EGM to ensure the authenticity of the software that may be stored on less secure memory subsystems, such as mass storage devices. Trusted memory devices and controlling circuitry are typically designed to not enable modification of the code and data stored in the memory device while the memory device is installed in the EGM. The code and data stored in these devices may include authentication algorithms, random number generators, authentication keys, operating system kernels, etc. The purpose of these trusted memory devices is to provide gaming regulatory authorities a root trusted authority within the computing environment of the EGM that can be tracked and verified as original. This may be accomplished via removal of the trusted memory device from the EGM computer and verification of the secure memory device contents is a separate third party verification device. Once the trusted memory device is verified as authentic, and based on the approval of the verification algorithms included in the trusted device, the EGM is enabled to verify the authenticity of additional code and data that may be located in the gaming computer assembly, such as code and data stored on hard disk drives.

In at least one embodiment, at least a portion of the trusted memory devices/sources may correspond to memory that cannot easily be altered (e.g., “unalterable memory”) such as EPROMS, PROMS, Bios, Extended Bios, and/or other memory sources that are able to be configured, verified, and/or authenticated (e.g., for authenticity) in a secure and controlled manner.

According to one embodiment, when a trusted information source is in communication with a remote device via a network, the remote device may employ a verification scheme to verify the identity of the trusted information source. For example, the trusted information source and the remote device may exchange information using public and private encryption keys to verify each other's identities. In another embodiment, the remote device and the trusted information source may engage in methods using zero knowledge proofs to authenticate each of their respective identities.

EGMs storing trusted information may utilize apparatuses or methods to detect and prevent tampering. For instance, trusted information stored in a trusted memory device may be encrypted to prevent its misuse. In addition, the trusted memory device may be secured behind a locked door. Further, one or more sensors may be coupled to the memory device to detect tampering with the memory device and provide some record of the tampering. In yet another example, the memory device storing trusted information might be designed to detect tampering attempts and clear or erase itself when an attempt at tampering has been detected.

Mass storage devices used in a general purpose computing devices typically enable code and data to be read from and written to the mass storage device. In a gaming environment, modification of the gaming code stored on a mass storage device is strictly controlled and would only be enabled under specific maintenance type events with electronic and physical enablers required. Though this level of security could be provided by software, EGMs that include mass storage devices include hardware level mass storage data protection circuitry that operates at the circuit level to monitor attempts to modify data on the mass storage device and will generate both software and hardware error triggers should a data modification be attempted without the proper electronic and physical enablers being present.

It should be appreciated that the terminology used herein is for the purpose of describing particular aspects only and is not intended to be limiting of the disclosure. For example, the singular forms “a”, “an” and “the” are intended to include the plural forms as well, unless the context clearly indicates otherwise. In another example, the terms “including” and “comprising” and variations thereof, when used in this specification, specify the presence of stated features, steps, operations, elements, and/or components, but do not preclude the presence or addition of one or more other features, steps, operations, elements, components, and/or groups thereof. Additionally, a listing of items does not imply that any or all of the items are mutually exclusive nor does a listing of items imply that any or all of the items are collectively exhaustive of anything or in a particular order, unless expressly specified otherwise. Moreover, as used herein, the term “and/or” includes any and all combinations of one or more of the associated listed items. It should be further appreciated that headings of sections provided in this document and the title are for convenience only, and are not to be taken as limiting the disclosure in any way. Furthermore, unless expressly specified otherwise, devices that are in communication with each other need not be in continuous communication with each other and may communicate directly or indirectly through one or more intermediaries.

Various changes and modifications to the present embodiments described herein will be apparent to those skilled in the art. For example, a description of an embodiment with several components in communication with each other does not imply that all such components are required, or that each of the disclosed components must communicate with every other component. On the contrary, a variety of optional components are described to illustrate the wide variety of possible embodiments of the present disclosure. As such, these changes and modifications can be made without departing from the spirit and scope of the present subject matter and without diminishing its intended technical scope. It is therefore intended that such changes and modifications be covered by the appended claims.

The invention is claimed as follows:

1. A system comprising:
a processor; and
a memory device that stores a plurality of instructions that, when executed by the processor following a receipt of first data associated with a gaming establishment personnel identification device and an establishment, based at least in part on the first data, of a designated mode of a gaming establishment device, cause the processor to:
determine if any currency is received in association with the gaming establishment device, and
responsive to an amount of currency being received in association with the gaming establishment device:
determine any issuance of any ticket vouchers in association with the gaming establishment device, and
responsive to an issuance of a ticket voucher in association with the gaming establishment device, communicate, to a component of a gaming establishment device management system, data associated with the receipt of the amount of currency, the occurrence of the issuance of the ticket voucher and second data associated with the gaming establishment personnel identification device.

2. The system of claim 1, wherein the issuance of the ticket voucher occurs following a meter of the gaming establishment device being reset.

3. The system of claim 2, wherein the issuance of the ticket voucher occurs following manufactured funds being added to a credit balance of the gaming establishment device.

4. The system of claim 1, wherein the ticket voucher comprises a virtual ticket voucher.

5. The system of claim 1, wherein the ticket voucher is associated with a potentially illegal ticket voucher state.

6. The system of claim 1, wherein the second data associated with the gaming establishment personnel identification device comprises a subset of the first data associated with the gaming establishment personnel identification device.

7. The system of claim 1, wherein the second data associated with the gaming establishment personnel identification device comprises an identifier of gaming establishment personnel.

8. The system of claim 1, wherein the gaming establishment device comprises an electronic gaming machine.

9. The system of claim 1, wherein the data communicated to the component of the gaming establishment device management system results in at least one of: a revocation of access to the designated mode of the gaming establishment device in association with the gaming establishment personnel identification device, a redemption limitation associated with the ticket voucher, a generation of a first report inclusive of the occurrence of the receipt of the amount of currency, and a generation of a second report inclusive of the issuance of the ticket voucher.

10. A system comprising:
a processor; and
a memory device that stores a plurality of instructions that, when executed by the processor following enabling an identified electronic gaming machine operator access to service an electronic gaming machine and in association with a determined clearing of a meter of the electronic gaming machine, cause the processor to:
determine any receipt of any currency by a payment acceptor of the electronic gaming machine, and
responsive to an amount of currency being received by the payment acceptor of the electronic gaming machine:
determine any printing of any ticket vouchers by a ticket printer of the electronic gaming machine, and
responsive to a ticket voucher being printed, communicate, to a component of a gaming establishment device management system, data associated with each of the receipt of the amount of currency, the occurrence of the printing of the ticket voucher and the identified electronic gaming machine operator.

11. The system of claim 10, wherein the clearing of the meter of the electronic gaming machine occurs following manufactured funds being added to a credit balance of the electronic gaming machine.

12. A method of operating a system, the method comprising:
following a receipt of first data associated with a gaming establishment personnel identification device and an establishment, based at least in part on the first data, of a designated mode of a gaming establishment device:
determining, by a processor, if any currency is received in association with the gaming establishment device, and
responsive to an amount of currency being received in association with the gaming establishment device:
determining, by the processor, any issuance of any ticket vouchers in association with the gaming establishment device, and
responsive to an issuance of a ticket voucher in association with the gaming establishment device, communicating, to a component of a gaming establishment device management system, data associated with the receipt of the amount of currency, the occurrence of the issuance of the ticket voucher and second data associated with the gaming establishment personnel identification device.

13. The method of claim 12, wherein the issuance of the ticket voucher occurs following a meter of the gaming establishment device being reset.

14. The method of claim 13, wherein the issuance of the ticket voucher occurs following manufactured funds being added to a credit balance of the gaming establishment device.

15. The method of claim 12, wherein the ticket voucher comprises a virtual ticket voucher.

16. The method of claim 12, wherein the ticket voucher is associated with a potentially illegal ticket voucher state.

17. The method of claim 12, wherein the second data associated with the gaming establishment personnel identification device comprises a subset of the first data associated with the gaming establishment personnel identification device.

18. The method of claim 12, wherein the second data associated with the gaming establishment personnel identification device comprises an identifier of gaming establishment personnel.

19. The method of claim 12, wherein the gaming establishment device comprises an electronic gaming machine.

20. The method of claim 12, wherein the data communicated to the component of the gaming establishment device management system results in at least one of: a revocation of access to the designated mode of the gaming establishment device in association with the gaming establishment personnel identification device, a redemption limitation associated with the ticket voucher, a generation of a first report inclusive of the occurrence of the receipt of the amount of currency, and a generation of a second report inclusive of the issuance of the ticket voucher.
